(19) United States
(12) Patent Application Publication
(10) Pub. No.: US 2014/0074734 A1
(43) Pub. Date: Mar. 13, 2014

(54) METHOD AND SYSTEM FOR MARKETING AND SELLING WATER RIGHTS

(71) Applicant: Pinnacle Software, LLC, Salt Lake City, UT (US)

(72) Inventors: Jesse R. Lassley, Cottonwood Heights, UT (US); Collin Green, Herriman, UT (US); Michael Bemis, Camarillo, CA (US)

(73) Assignee: Pinnacle Software, LLC, Salt Lake City, UT (US)

(21) Appl. No.: 14/023,750

(22) Filed: Sep. 11, 2013

Related U.S. Application Data
(60) Provisional application No. 61/699,791, filed on Sep. 11, 2012.

(51) Int. Cl. G06Q 50/16; G06Q 30/02

(52) U.S. Cl. CPC G06Q 50/165; G06Q 30/0278
USPC 705/306; 705/315

(57) ABSTRACT

A water rights marketing system, methods, and products that perform maintaining a listings database including listings data representative of a plurality of water right listings, receiving data representative of a search query for locating one or more relevant water right listings included in the plurality of water right listings, the search query including search criteria defined by a user of the user device, identifying the one or more relevant water right listings having at least one listings data element that satisfies the search criteria, and presenting the one or more relevant water right listings on a display associated with the user device for access by the user.

### PRIORITY

This application claims priority under 35 U.S.C. §119(e) to U.S. Provisional Patent Application No. 61/699,791 filed Sep. 11, 2012, the contents of which are incorporated herein by reference in their entirety.

### BACKGROUND

Water is one of the most important and vital natural resources. It is the very life-blood of a sustainable society. In the United States, the ownership and use of water is governed by law, usually state law. There are two general legal systems for the regulation of water. In the eastern United States, water is regulated by the riparian water rights doctrine. In the western United States, where the climate is often arid and water is more scarce, water is regulated by the prior appropriation doctrine. Under the prior appropriation doctrine, all naturally-occurring waters are deemed to be owned by the public as a whole, but regulated by the states as trustees for the public. The states administer the regulation of water through state regulatory agencies, usually headed by an official often called the “state engineer.” All water not already appropriated, i.e., not being used, is available for appropriation and use by any person for a beneficial purpose. Because water is owned by the public, one who desires to appropriate water to put it to a beneficial use (referred to as an “appropriator”) does not “own” the water, but obtains only a right to use the water. The appropriator therefore owns only a “water right.”

A water rights agency maintains records and information associated with each water right, usually with a separate file for each water right. The paper records within a water right file are available for review and inspection by members of the public at the office of the water rights agency. In addition, most water rights agencies maintain electronic copies of water rights records, such as in a computer database, which allows the water rights agencies as well as the public to electronically search for and retrieve water rights records and information. Some of these databases and water rights records are available to the public via the Internet.

### BRIEF DESCRIPTION OF THE DRAWINGS

The novel system, methods, and products described herein can be understood in light of FIGS. 1-7, in which:

FIG. 1 depicts an exemplary embodiment of a water rights marketing system and network.

FIG. 2 depicts exemplary components of the water rights marketing system.

FIGS. 3A-3E depict representations of a user interface according to various exemplary embodiments of the water rights marketing system.

FIG. 4 depicts a representation of a user interface according to an exemplary embodiment of the water rights marketing system.

FIGS. 5-7 depict flow charts of exemplary embodiments of the water rights marketing system and method.

FIGS. 8 and 9 depict representations of a user interface according to various exemplary embodiments of the water rights marketing system.

FIGS. 10 and 11 depict flow charts of exemplary embodiments of the water rights marketing system and method.

Together, the Figures illustrate specific aspects of the novel system, methods, and products described herein and constitute a part of the specification. Together with the following description, the Figures demonstrate and explain principles of the water rights marketing system, methods, and products.

### DETAILED DESCRIPTION

The following detailed description includes specific details in order to provide a thorough understanding of the novel water rights marketing system and methods. Reference is also made to the accompanying drawings which form a part hereof, and in which are shown by way of illustration specific embodiments in which a water rights marketing system and methods may be implemented. These embodiments are described in sufficient detail to enable those skilled in the art to implement and/or practice the novel water rights marketing system and methods, and it is to be understood that other embodiments may be utilized and that structural, logical, and other changes may be made without departing from the spirit and scope of the teachings herein. The following detailed description is, therefore, not to be taken in a limiting sense.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

The various jurisdictions that administer and regulate water rights do so through regulatory agencies and entities (“water rights agencies”) according to their own laws, regulations, and procedures, but the methods of administering water rights in all jurisdictions under the prior appropriation doctrine are similar. Water rights agencies include any federal, Indian tribe, state, or local government entity or body that regulates or administers water rights, including but not limited to state executive agencies (often headed by an official titled a “state engineer”), as well as courts and other judicial tribunals. Examples of water rights agencies include, but are not limited to, the Utah Division of Water Rights, California Division of Water Rights (State Water Resources Control Board), State of Washington Department of Ecology, Oregon Water Resources Department, Idaho Department of Water Resources, Arizona Department of Water Resources, New Mexico Office of the State Engineer, Colorado Division of Water Resources, Wyoming State Engineer's Office, Montana Water Rights Bureau, North Dakota State Water Commission, South Dakota Division of Environmental Services (Water Rights Program), Nebraska Department of Natural Resources, Kansas Division of Water Resources (Department of Agriculture), Oklahoma Water Resources Board, Texas Commission on Environmental Quality, Alaska Division of Mining, Land, and (Water Department of Natural Resources), Nevada Water Resources Division, and any of their related agencies. However, a water rights agency may be any government agency or entity that administers water rights.

New water rights may be created by several different methods, each of which is defined more specifically in the relevant jurisdiction's water laws. By way of example, in one method new water rights are created by filing an application with a water rights agency to appropriate water. If approved by the water rights agency, the applicant may then begin the process of putting the water to use, such as by drilling a well or installing a diversion dam in a stream. Once the water has been put to use, the water right applicant/owner may then perfect the water right by obtaining a certificate or license from the water rights agency. Regardless of how a water right is created, a water right, whether perfected or unperfected, gives the water right owner the right to use water only as approved by the water rights agency. The following parameters of a water right may be specified and limited by the water rights agency: (i) the quantity of water approved for use, defined in volume or flow rate; (ii) the approved purposes for which the water can be used (the “nature of use”); (iii) the approved point(s) of diversion (“POD”) where the water can be diverted or withdrawn from the natural hydrologic system, such as from a stream or a groundwater well; (iv) the approved places of use for the water (“POU”); and (v) the periods during the year when the water can be used. Water rights may also be limited by a depletion limit, explained below in more detail.

In addition, water rights agencies assign a water right a priority date, often based on when the water was first beneficially used or first appropriated. In times of shortage, the water rights with the highest (oldest) priority will be the first to receive water, while those with later priorities will be the first to have the diversion or use of water curtailed.

A standard unit of volume for a water right is the acre-foot, which is the volume of water that covers one acre of land one foot deep. One acre-foot of water is approximately 325,851 gallons. A standard unit of flow rate is second-feet, or cubic feet per second (cfs). Approved natures of use of water often include, but are not limited to, uses such as domestic, agricultural, irrigation, industrial, manufacturing, mining, municipal, stockwatering, storage, power production, and instream flows (e.g., fish habitat).

Water rights are limited to the quantity of water actually depleted, or consumed, by the approved use(s). This is referred to as the “depletion limit.” An appropriator diverts water from the natural hydrologic system and then uses it in accordance with the approved water right. In most instances, some of the diverted water is completely consumed, such as by uptake into plants, drinking by people and animals, and evaporation. This water is considered to be permanently removed from the hydrologic cycle, i.e., “depleted.” On the other hand, some of the diverted water is not depleted, but instead returns to the natural hydrologic system after it has been used, such as by seepage into the groundwater or runoff into surface streams and waters.

An example illustrates this concept. A farmer has a water right approved for irrigation of a 10-acre field. The approved POD is at a weir on a nearby river that diverts a portion of the river water into the farmer's ditch, where the water travels for 1,000 yards until it reaches the field. At the field, the farmer flood-irrigates the property, and the runoff passes into a drain ditch that returns the runoff water back into the river at a point farther downstream from the weir POD. If 40 acre-feet is diverted at the river by the weir, a portion of that water (say, 3 acre-feet) will seep into the ground as it travels through the ditch, and a small portion will evaporate (say, 1 acre-foot). Thus, 36 acre-feet of water reach the field. At the field, the crops consume 25 acre-feet. A portion of the remaining 11 acre-feet of water returns to the natural system by seeping into the groundwater at the field and as it travels through the drain ditch, and the remainder flows back into the river from the drain ditch. In this case, 26 acre-feet are depleted (25 acre-feet consumed by the plants and 1 acre-foot lost to evaporation), and 14 acre-feet are “return flow.” The depletion limit is said to be 26 acre-feet, and the depletion limit is said to be 65% (26/40).

On the other hand, water approved for municipal purposes may often be considered to be 100% consumptive by the water rights agency. Thus, if a city diverts 1,000 acre-feet from a river into a water tank for use in the municipal water system, all 1,000 acre-feet may be consumed (or at least deemed by the water rights agency to be consumed) by the city's residents and industries. The depletion limit is said to be 100%.

Water rights are not static. The approved nature of use, PODs, POUs, and period of use for a water right (the “heretofore” parameters) can be changed or transferred to new locations, new periods of use, and/or new purposes of use (the “hereafter” parameters). To make such a change, the water right owner must often file an application with the water rights agency (referred to herein as a “change application”). The water rights agency considers the merits of the change application, and then approves or rejects the change application. Once a change application has been approved by the water rights agency, the water right owner may then begin to physically make the change, such as by developing a new point of diversion, applying the water to a new place of use, or using the water for a different purpose. Once the change has been completed and the water put to beneficial use in accordance with the change, the water right owner may then perfect the change by obtaining a license or certificate from the water rights agency.

For example, if a water right owner desires to move the approved POD from a point on a stream to an underground water well, the water right owner must file a change application with the water rights agency, identifying the stream diversion as the heretofore POD and the proposed well location as the hereafter POD. If the water rights agency approves the change application, the water right owner may then begin drilling the well. When the well is complete and has produced water, the water right owner may then perfect the POD change by obtaining a certificate for the change from the water rights agency.

One of the underlying principles of water law under the prior appropriation doctrine is that a water right cannot be enlarged by a change beyond the original limits of the water right. What this means is that no water right change can increase the depletion limit. Consider, for example, a typical scenario. The farmer in the above-described example sells his 10-acre field to be developed, and sells the water right to the city to be added to the city water supply to provide water to the new development. A change application would be filed to change the approved POD from the river to one of the city's groundwater wells and to change the approved use from irrigation to municipal. Although the farmer's water right was originally approved for 40 acre-feet, the water rights agency would approve the change application for only 26 acre-feet for municipal use. The original water right would thus be cut by 14 acre-feet to maintain the same depletion limit, i.e. 26 acre-feet.

Another type of water right is a water right exchange. A water right exchange involves the release of water into a stream, reservoir or other body of water in exchange for a like quantity of water withdrawn at another point. For example, a person may divert water from a groundwater well in exchange for releasing the same quantity of water, such as from a reservoir, into a river upstream from the groundwater well. Such an exchange is accomplished by first filing an exchange application with the water rights agency. Once the exchange application is approved, the applicant may then begin to make the exchange and put the water to use in accordance with the approval of exchange application.

As used herein, a “water right” includes all types of water rights administered or regulated by a water rights agency, whether perfected or unperfected, and whether created or arising by a court decree or order, a certificate issued by the water rights agency, a claim filed with a water rights agency or a court, an approved application to appropriate, an approved change application, a water right segregation, and/or an approved exchange application, or any other method under the law of the jurisdiction for creating a water right. Unless otherwise noted, a “water right” also includes water shares in water, irrigation, canal, or ditch companies, and the like.

It should be appreciated that each jurisdiction may have its own terminology and procedural and substantive nuances with respect to water rights regulation and administration, and that the terms and procedures used and referenced herein are not intended to be limiting but only representative of the nature and type of water right and associated water right data among all jurisdictions.

The water rights marketing system, methods, and products described herein provide a unique and powerful tool for collecting and accessing large amounts of information about water rights, transactions involving water rights, and market information related to water rights, and conveying the information to users. The water rights marketing system, methods, and products described herein also provide methods for normalizing the market value of water rights. The water rights marketing system, methods, and products utilize a database of water rights data in conjunction with data and information received from water rights agencies and buyers and sellers of water rights to provide a powerful tool for marketing and selling water rights. The water rights marketing system, methods, and products provide a single location for identifying and viewing all water right data and information relevant to a sale, and provide a single location for sellers to find buyers and vice versa.

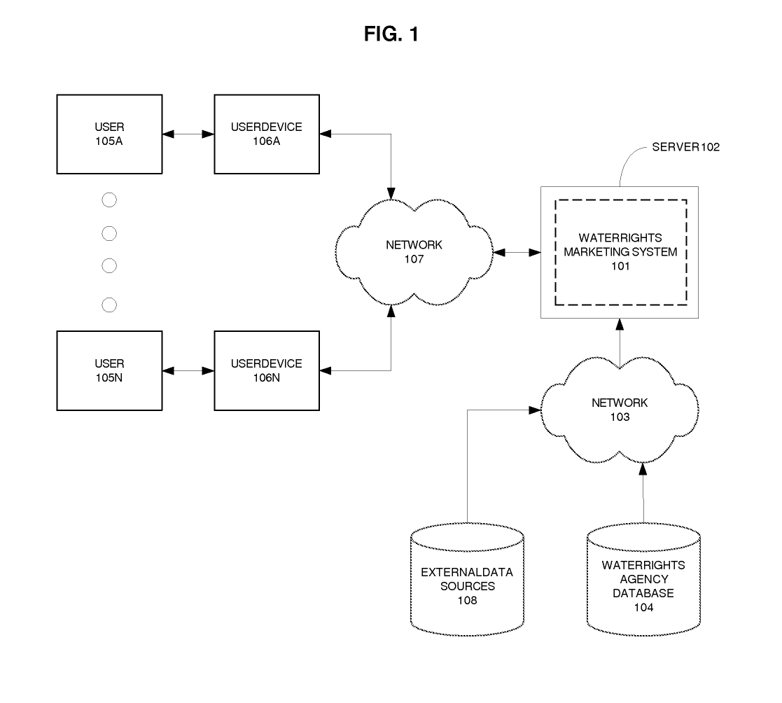

FIG. 1 shows a water rights marketing system 101 and associated network. The water rights marketing system 101 may be located on a server 102 and may be connected to a water rights agency database 104 via a network 103. The server 102 may receive water rights data from the water rights agency database 104 via the network 103 as well as from users 105A . . . 105N via user devices 106A . . . 106N. The water rights marketing system 101 may store the received water rights data in one or more databases. User devices 106A . . . 106N communicate with server 102 via a network 107. Water rights marketing system 101 may receive a search query from a user 105A via a user device 106A transmitted to the server 102 via network 107. Based on the search query from user 105A, the water rights marketing system 101 retrieves the relevant data and information called for by the user's search query and presents the search results to the user 105A on a display device associated with user device 106A.

Server 102 may comprise one or more servers, computers, processors, or other devices capable of storing and/or executing the water rights marketing system 101 to perform the methods described herein. User device 106A may be any type of electronic computing device configured to communicatively connect with the water rights marketing system 101 via a network (e.g., network 107) and receive and present, on a display device associated with user device 106A, visual or graphical search results. User device 106A may also be configured to present search results in audio format. The user device 106A may include, but is not limited to, a computer, laptop, tablet, mobile phone, smartphone, personal digital assistant, gaming console, television, Internet television, set-top-box, and the like. Indeed, the user device 106A may include any type of computer processor configured to communicate via a network with the water rights marketing system 101 and display results visually, graphically, or audibly, either on the user device 106A or on another visual display or audio device connected to the user device 106A, such as a monitor or touch-screen. Any number of users 105A . . . 105N and user devices 106A . . . 106N may communicate with the server 102 and utilize the water rights marketing system 101 at any given time.

Networks 103 and 107 may include any type of electronic network, including, but not limited to, the Internet, a local area network, wireless area network, VPN, satellite network, fiber optic network, and the like. The connection to the networks 103 and 107 may be accomplished by user devices 106A . . . 106N and water rights monitoring system 101 via a network interface device, such as a telephone modem, a cable modem, a DSL line, a satellite, a cellular network, a router, gateway, hub, and the like. Networks 103 and 107 may be the same networks or may be different networks.

In one exemplary embodiment, water rights marketing system 101 may be housed on the same server 102 as the water rights agency database 104. In this embodiment, the water rights marketing system 101 may be maintained and operated as part of the water rights agency database 104.

Water rights agency database 104 contains water rights data regarding the water rights administered by the water rights agency. “Water rights data,” as used herein, includes any data and/or information related to water rights that is maintained by a water rights agency and/or stored in water rights agency database 104, and any data maintained, created, updated, uploaded, or inputted into water right marketing system 101 by one or more users 105A . . . 105N. Water rights data includes data representative of a water right's reference or identification number, owner(s), POD(s), POU(s), quantity of use, nature of use, period of use, priority date, storage rights, status, associated change applications and exchange applications, extensions of time, non-use applications, segregation applications, the basis of the water right, heretofore and hereafter parameters of the water right, water reuse applications, well depth, water sources (e.g., lakes, rivers, streams, springs, aquifers), hydrologic basins and their boundaries, water rights agency policies, groundwater management plans, hearing transcripts and recordings, photographs, maps, and any other applications or information associated with water rights. The status of a water right may be classified by the water rights agency as approved, rejected, withdrawn, lapsed, or certificated (i.e., perfected). The basis for the water right may include, but is not limited to, a court order or decree, application to appropriate, change application, exchange application, water right segregation, claim, etc. Heretofore and hereafter parameters of a water right include, but are not limited to, PODs, POUs, quantity of use, nature of use, period of use, priority date, and storage rights. Water rights data also includes data representative of water rights information provided by users 105A . . . 105N, such as descriptions, notes, owner history, sales and transaction information, legal actions and documents, technical information and documents, maps, surveys, photographs, and the like.

Water rights marketing system 101 may also optionally be communicatively coupled to one or more external data sources 108 for providing additional data to the water rights marketing system 101. For example, in one exemplary embodiment, external data sources 108 may include one or more real property databases containing real property data, i.e. data representative of real property parcels. The real property database may be one or more databases containing geo-referenced parcel boundary line data, such as a database of real property parcels maintained or administered by a state tax commission, county assessor, or county recorder. The real property data stored in the real property database for each parcel may also include data representative of a parcel number, owner name and contact address, parcel address, and legal description. In this embodiment, the water rights marketing system 101 may receive real property data from a real property database and store it in the water rights marketing system 101. In addition, a real property database may include data representative of real property that is maintained, created, or updated, or input into the water right marketing system 101 by one or more users of the system, such as descriptions, notes, photographs, and other information relating to real property.

External data sources 108 may also include any other private, public, and quasi-public data sources and databases having data and information regarding or relating to water rights. For example, external data sources 108 may include any local, state, or federal agencies, legislative bodies, planning and zoning entities, entities governing or relating to the environment, drinking water, and/or water resources, the Environmental Protection Agency, weather centers and services, police and fire departments, military departments, hazardous waste agencies and firms, universities, research entities, businesses and associations such as multiple listing services, real estate brokerages, law firms, engineering firms, geologists, title companies, financial and lending firms, investment firms, water companies, and irrigation companies, individuals, and any other entity that collects or has data regarding or relevant to water rights.

In another embodiment, external sources 108 include sources that may upload, input, or otherwise manually or automatically provide data to the water rights marketing system 101. By using data from private sources, the system 101 may collect and provide access to data related to water rights that is not maintained by water rights agencies or available to users. In another exemplary embodiment, the system 101 obtains additional data from other sources through use of application program interfaces (“APIs”). The APIs allow the system 101 to obtain any data in any format and use the data in a water rights marketing method.

Water rights marketing system 101 may be stored on computer media readable by removable disk drive or stored in solid state memory, volatile or otherwise in communication with a processor in user device 106A. For example, water rights marketing system 101 may be installed on the user device 106A hard drive, or may be software accessed from a CD-ROM or other removable storage media. In such an embodiment, all water rights data and external data is previously obtained, such as from a water rights agency database 104 and external data sources 108, and stored in water rights marketing system 101 databases, and may be updated periodically. In another exemplary embodiment, water rights marketing system 101 may comprise a plug-in for other applications and/or may interface with other applications.

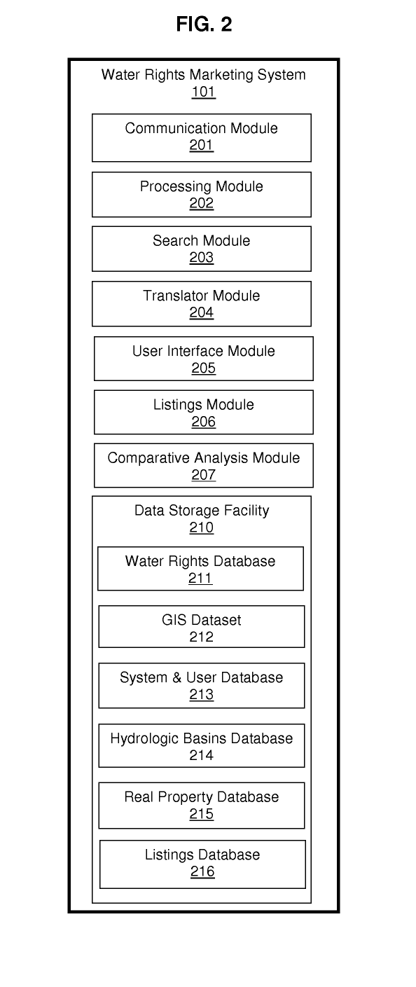

Referring now to FIG. 2, components of the water rights marketing system 101 in an exemplary embodiment are shown in more detail. As shown, water rights marketing system 101 may include a communication module 201, a processing module 202, a search module 203, a translator module 204, a user interface module 205, a listings module 206, a comparative analysis module 207, and a data storage facility 210. The components of water rights marketing system 101 may communicate with one another, including sending data to and receiving data from one another via communication infrastructure, using any suitable communication technologies.

Communication module 201 may be configured to facilitate communication between system 101 and user devices 106A . . . 106N, water rights agency databases 104, and external data sources 108. In particular, communication module 201 may be configured to transmit and/or receive communication signals and/or data to/from user devices 106A . . . 106N, water rights agency databases 104, and external data sources 108. Examples of communication module 201 may include, without limitation, a wired network interface (such as a network interface card), a wireless network interface (such as a wireless network interface card), a modem, and any other suitable interface.

Processing module 202 may include one or more hardware processors and may be configured to execute and/or direct execution of one or more of the water rights marketing system processes or operations described herein. Processing module 202 may direct execution of operations in accordance with computer-executable instructions such as may be stored in data storage facility 210 or another computer-readable medium.

Data storage facility 210 may include one or more data storage media, devices, and/or configurations and may employ any type, form, and combination of data storage media and/or devices. For example, data storage facility 210 may include, but is not limited to, a hard drive, network drive, flash drive, magnetic disc, optical disc, random access memory (“RAM”), dynamic RAM (“DRAM”), other non-volatile and/or volatile data storage units, holographic storage medium, or a combination or sub-combination thereof. Electronic data, including data described herein, may be temporarily and/or permanently stored in data storage facility 210.

In some examples, data may be arranged in one or more databases residing within data storage facility 210. For example, data storage facility 210 may include a water rights database 211, a geographic information system (“GIS”) reference dataset 212, a system and user database 213, a hydrologic basins database 214, a real property database 215, and a listings database 216.

Water rights database 211 stores water rights data received from one or more water rights agency databases 104, external data sources 108, and/or users. Water rights database 211 may comprise one or more tables or relational databases for water rights data, but may be any type of database known to those of skill in the art capable of implementation in the present system and methods. In one embodiment, water rights data is stored in water rights databases 211 in the same form and type of databases as the data is stored in the water rights agency database 104. In this embodiment, the water rights database 211 may be a copy of the water rights agency database 104. The water rights database 211 may include all of the water rights data included in the water rights agency database 104. For example, in one embodiment, the water rights database 211 for Utah may comprise separate tables for water rights, owners, change applications, heretofore PODs, heretofore and hereafter nature of use, and correlations among the tables, such as which water rights are evidenced by which changes.

Water rights database 211 may also include data representative of water rights agency administrative policies. Often, a water rights agency will issue or promulgate policies or groundwater management plans that affect water rights within specific hydrologic basins or other geographic regions. For example, the Utah Division of Water Rights has adopted a policy prohibiting certain POD changes within a portion of the Tooele Valley basin. Data representative of administrative policies stored in data storage facility 210 may include various published archives of hydrologic basin policies and may also include lesser known effective policy rules such as “hints or tips” for user reference.

GIS dataset 212 correlates to geo-referenced water rights data and may comprise a base layer of search results output to a user device 106A. The GIS dataset 212 is used to visually present the geo-referenced water rights data, hydrologic basins data, real property data, and any other data stored in the data storage facility 210. In one embodiment, GIS dataset 212 comprises a geo-reference base layer such as a map or ortho-rectified satellite or aerial image. Any type of map may be used as the geo-reference base layer, including a street map, political boundaries map, topographical map, U.S. Geological Survey (USGS) maps, surveys, and the like. GIS dataset 212 may be based on a geographic coordinate system or a projected coordinate system. GIS dataset 212 is capable of presenting any geographically referenced data on the geo-reference base layer, and is characterized by either raster datasets or vector datasets. GIS dataset 212 may be derived from any free, open source, or commercially available GIS web-mapping or imaging application, API or software development kit, such as, but not limited to, Google Maps, GoogleEarth, and OpenLayers. Geo-referenced data stored in the water rights database 211, hydrologic basins database 214, real property database 215, listings database 216, and any other geo-referenced data is correlated with GIS dataset 212 so that it may be presented on the geo-reference base layer in the search results. GIS dataset 212 may also include other datasets besides the geo-reference base layer, including but not limited to datasets for features (points, lines, polygons), attributes, and continuous surfaces.

The system and user database 213 stores system and user data related to the water rights marketing system 101 and its users. Such system and user data includes, but is not limited to, a table of registered users, user account settings, user profiles, user billing data, user reports, user search histories, corrections made by owners, user logins, bandwidth usage, customer service requests, error messages, access permissions, and the like. Indeed, any type of information about the water rights marketing system 101 and its users may be included in the system and user database 213.

Hydrologic basins database 214 may contain hydrologic basins data. Many water rights agencies geographically divide their jurisdiction according to hydrologic basins and regulate and administer water rights according to the hydrologic basins in which the water rights are located. Hydrologic basins data received from the water rights agency databases 104 generally comprise the geo-referenced location vector data that define hydrologic basins as polygons. Hydrologic basins data may also include any other data associated by the water rights agency database 104 with the hydrologic basins, such as hydrologic basin identifiers, and correlations to the hydrologic basins data. The hydrologic basins data is geographically referenced to GIS dataset 212 so that the hydrologic basins may be displayed on the geo-reference base layer, such as by showing basin boundaries or shading or cross-hatching the basin areas.

Real property database 215 may contain real property data received from an external data source 108 (e.g., real property database). For example, real property database 215 may store geo-referenced vector parcel data referenced to GIS dataset 212. Real property database 215 may be configured to communicate with search module 203 to allow a user to perform a search query based on geographic location parameters, such as a parcel number or identifier, rather than a water right.

Listings database 216 maintains data representative of water right listings. Water right listings may be created by users through listings module 206 as described herein.

The water rights marketing system 101 may also maintain a unique set of water rights database 211, GIS dataset 212, hydrologic basins database 214, real property database 215, listings database 216, and the like for each different jurisdiction. For example, the water rights marketing system 101 may include a set of databases for each state, referred to as the “state databases.”

Listings module 206 allows users, such as sellers or their agents or brokers, to create water right listings for water rights listed for sale. Data representative of water right listings are stored in listings database 216. A water right listing is a record of an offer to sell a water right via the water rights marketing system 101. A water right listing includes listing information regarding the offer for sale, including but not limited to identification of the water right for sale, the seller's asking price, the quantity of water for sale, the number of water shares for sale, the water or irrigation company issuing the water shares for sale, locations of PODs or POUs for the water right, approved types of use (e.g. industrial, irrigation, stockwatering, domestic), the hydrologic basin in which the PODs are located, any water rights agency policies or orders affecting the water right, notes or information about historical usage of the water right, owner name, address, county, city, a map or other aerial photo showing geo-referenced water rights data for the listing, remarks, commission data, financing terms and options, a listing reference number, days on market, status of the listing (e.g., current, under contract, withdrawn, sold), a client name, a listing descriptor or name, co-agents, and any other information and documents included by the user creating the listing.

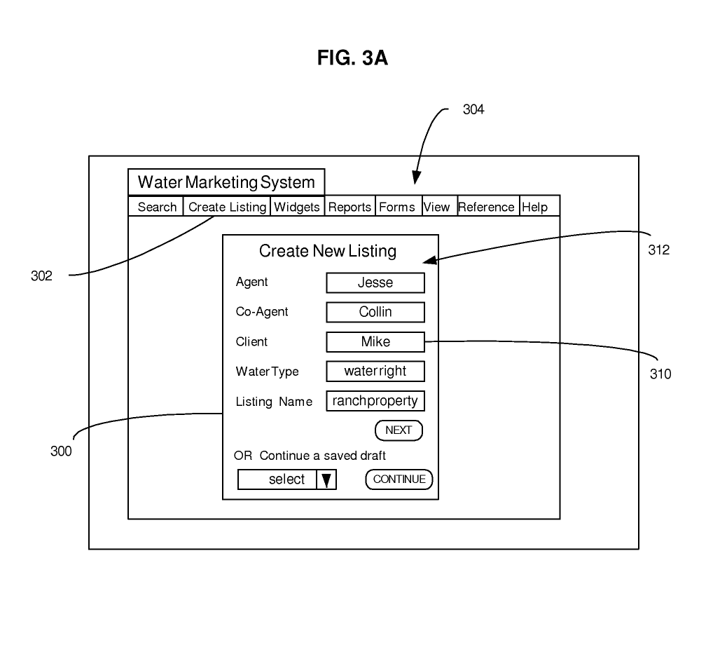

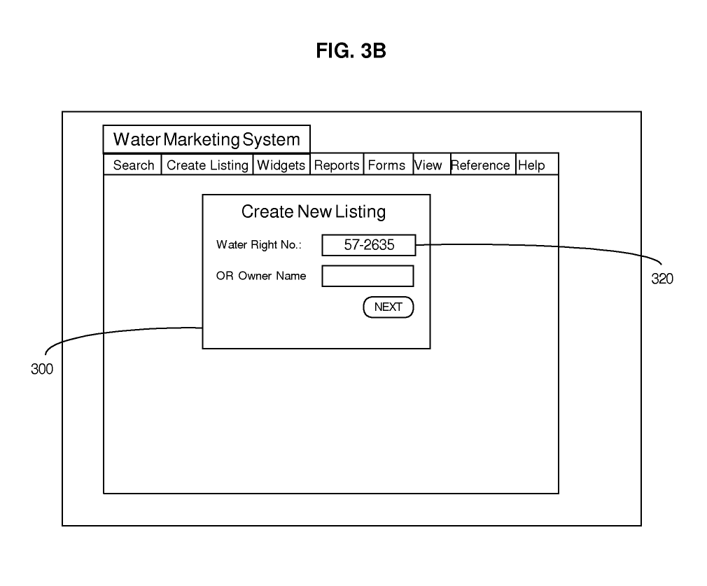

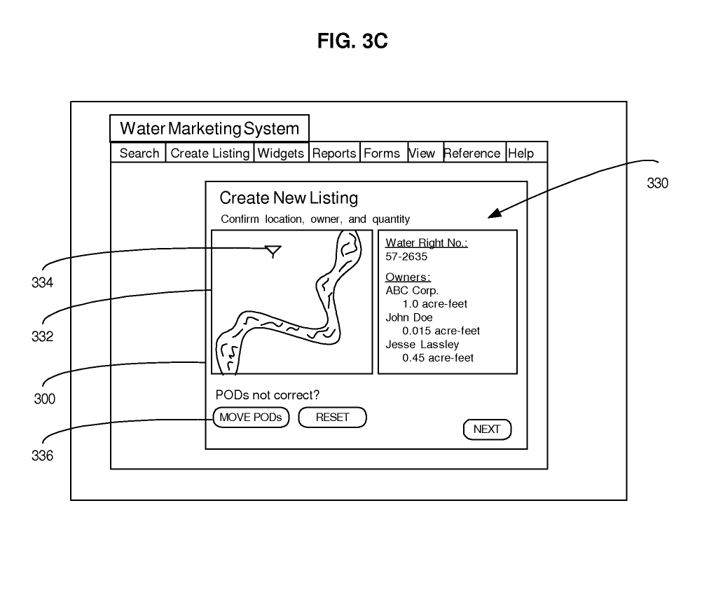

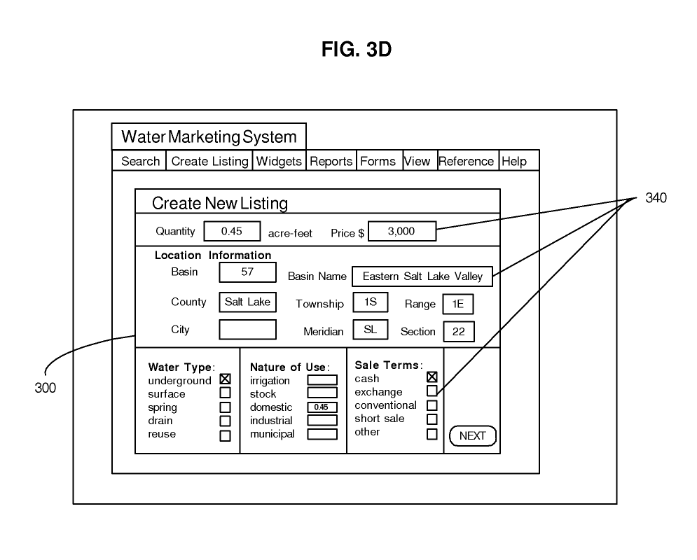

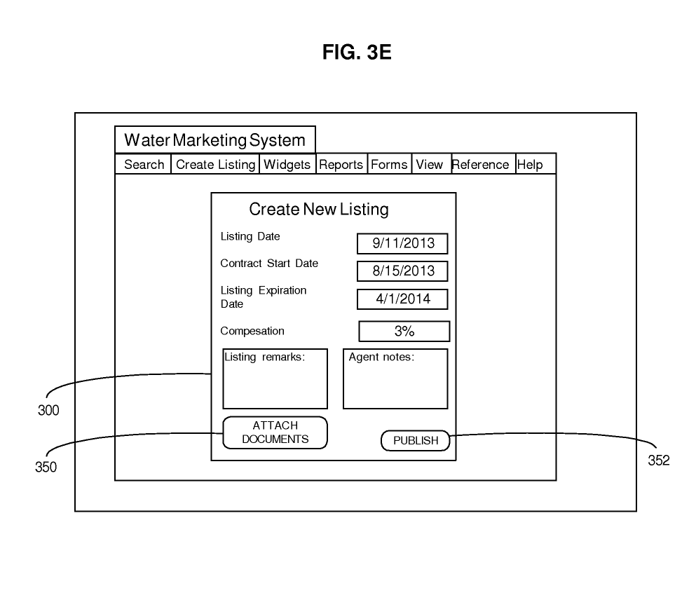

Listings module 206 may communicate with the components of water rights marketing system 101 and the databases in data storage facility 210 to facilitate the input of all desired listing information and documents regarding the offer for sale to create water right listings. FIGS. 3A-3E depict representations of a user interface 300 for creating a water right listing according to various exemplary embodiments of the water rights marketing system 101. As shown in FIG. 3A, listings module 206 and/or user interface module 205 may display a create listing user interface 300 for beginning the creation of a water right listing. Create listing user interface 300 may be presented in response to a user selection of a menu item 302 on graphical user interface 304. Create listing user interface 300 may include fields 310 for entering listing information 312, such as agent name(s), client name, water type, and a listing name. As shown in FIG. 3B, listings module 206 may communicate with search module 203 to allow the user to enter search terms (e.g., water right number and/or water right owner name) in search fields 320 to search water rights database 211 to identify one or more water rights for which the user wishes to create a water right listing. As shown in FIG. 3C, user interface 300 may display information 330 related to the selected water right for verification and confirmation by the user. As shown in FIG. 3D, user interface 300 may be configured to facilitate user input of listing information for the water right listing into one or more fields 340. Listings module 206 may pre-populate the fields 340 with water rights data obtained from water rights database 211.

“Listing data,” which is data representative of a water right listing, may include listing information inputted by a user, water rights data associated with the water right and stored in water rights database 211, any data obtained from external data sources 108, and any other information associated with the water right and/or water right listing. Listing data is stored in listings database 216 and/or referenced in listings database 216 to water rights database 211 and any other database as may suit a particular implementation. Listing information may be added and inputted to the water right listing at any time. For example, when a water right sells, a user may add transaction information associated with a sale of the water right to the water right listing, such as the sale price, sale terms, quantity of water sold, copies of contracts and agreements, and the like.

In one exemplary embodiment, as shown in FIG. 3C, user interface 300 includes a geo-reference base layer 332 showing a graphical object 334 representing a geo-referenced water rights data element associated with the selected water right, such as POD or POU. Listings module 206, via user interface 300, may allow the user to correct water right data that is obtained from water rights database 211. When the user corrects or modifies the water rights data, the water rights marketing system 101 may make a corresponding change in the listings database 216 and/or the water rights database 211. For example, as shown in FIG. 3C, user interface 300 provides a selectable option 336 for allowing a user to correct PODs by enabling movement of graphical object 334. If a POD is shown on geo-reference base layer 332 to be in the wrong location, a user may select selectable option 336 and then move graphical object 334 to the correct location on the geo-reference base layer 332, and may optionally enter an explanatory note regarding the correction. Corrections may be compiled into a log for archival purposes and data cleansing activities with the state agencies or water companies, etc.

Listings module 206 may also allow a user to upload listing information in the form of documents for selective access by one or more users. Such documents may include listing agreements and amendments, a confirmation request approval, affidavits of water use, water rights records, deeds, historical documents, legal documents, and any other document relevant to the water right listed for sale or relevant to the water right listing. For example, as shown in FIG. 3E, user interface 300 may include a selectable option 350 allowing a user to attach documents to the water right listing.

Once the listing information for a water right listing has been entered by a user and received by listings module 206, a user may select to publish the water right listing. For example, user interface may 300 may include a selectable option 352 to publish the water right listing. Data representative of the water right listing may then enter into a queue for publishing. The queue may allow the water right listing to be held for final approval before publishing. For example, a junior agent at a brokerage may utilize user interface 300 to create a water right listing and submit it to the queue, where the agent's managing broker can review the listing and then give final approval (such as through approval of a confirmation request) to approve it for publishing. In another embodiment, trusted partners can be designated to have authority to approve for publishing a water right listing in the queue. Trusted partners can be agents, brokers, owners, personal or legal representatives, executors, trustees, receivers, and the like. A water right listing in the queue can be edited and modified as necessary.

Listings module 206 may also be configured to deliver a notification, such as, but not limited to, an email, text message, voice message, SMS, MMS, or facsimile, to certain recipients desiring to know that the water right listing has been published by the system. Often the desired recipients include the agent or broker preparing the water right listing, the seller or the seller's representative, and any other agents, brokers, potential buyers, or other individuals to whom the user or client wishes the notice to be sent. The notification may include details about the water right listing, and/or it may provide a link to the system 101 where the water right listing can be viewed.

Listings module 206 may provide a confirmation request before a water right listing is published by the water rights marketing system 101. The confirmation request may simply be a web page or pop-up box requesting a user selection of a graphical object to approve the water right listing, or it may be a web page or link to a web page that is sent to another user (a user other than the user creating the water right listing) for a confirmation selection. Additionally or alternatively, water rights marketing system 101 may print the confirmation request to be signed by another user (such as the water right owner or a client). The printed confirmation page may then be uploaded to water rights marketing system 101 for the associated listing and stored in listings database 216 or system and user database 213, thus confirming final approval of the water right listing and providing a record of the approval.

Listings module 206 may be configured to suspend a water right listing in queue until a specific file or document is uploaded, such as a signed listing agreement between a water right owner and a listing agent, or a signed confirmation request approval.

After a water right listing has been approved for publishing, as described above, listings module 206 publishes the water right listing. A water right listing is published by providing it for selective access by other users (users other than the user or users who created and/or had authoring rights for the water right listing). After a water right listing has been published, the listing information can be modified and updated through listings module 206. Listings module 206 may also be configured to track and show changes made to the listing data. The types of users who may view these tracked changes can be limited to certain approved users.

In one embodiment, water rights marketing system 101 may limit authoring rights to create, modify, and view water rights listings to certain users, as may be set by user preferences. For example, only certain specified users may have access to create water right listings, such as attorneys, engineers, agents, and/or brokers who represent sellers of water rights. Access may be restricted and controlled through the subscription process, and may require independent verification of the identity of the users.

Access rights for some or all of the listing data, listing information, and documents associated with a water right listing may also be limited to certain users, as specified by one or more user preferences a user creating or managing the water right listing. For example, agents and brokers may set user preferences that limit access rights to commission information, listing agreements, confirmation pages, and the like, inasmuch as such information is often not needed by a potential buyer.

Water rights marketing system 101 may also include a search module 203 configured to facilitate a user 105A, by means of user device 106A, to search the listings database 216 for published water right listings and selectively access the published water right listings. Search module 203 may be configured to receive a user's search query from a user device 106A, to process the search query as described below, to communicate with the system databases, and to return to the user device 106A the results of the user's search query via a user interface. The user may search and selectively access water right listings as described herein in more detail.

Translator module 204 translates water rights data and other data received from sources external to the water rights marketing system 101, such as water rights agency databases 104, external data sources 108, and user of the water rights marketing system 101, to a form and format useable in the water rights marketing system 101 to run the processes described below. Translator module 204 allows the water rights marketing system 101 to run the same processes with only one set of instructions on all search queries for all jurisdictions. Translator module 204 allows the same front end of the system 101 to receive data from water rights agencies in multiple different jurisdictions and to deal with database schema changes. In one exemplary embodiment, because each jurisdiction and water rights agency uses its own terminology and field identifiers in its water rights agency databases 104, translator module 204 translates the data into a common format or identifier for easier use with the front end of the water rights marketing system 101. For example, Utah's CH_STATUS field is translated to CHANGE_STATUS. Another state may have a field named TRANSFER_STATUS, which would also translate to CHANGE_STATUS so the field name is the same from the front end for all state water rights data.

In another embodiment, translator module 204 may translate data obtained from water rights agency database 104 by consolidating related data into single rows in the tables. For example, water rights data maintained by a water rights agency may have a separate row for every instance that an owner or a POD is used in a water right application, thus leading to many duplicate rows and errors associated with new or updated data. The water rights marketing system 101 is structured to have one row for an owner, POD, or water right so as to eliminate the above-described problems. This is done by the translator module 204, which normalizes multiple rows in the water rights agency data into one row whenever the multiple rows are determined to be the same. For example, this may be done by matching the first name, last name, care of, address, address city, and address fields for water right owners and/or water right protesters. For PODs, the normalizing may be done by matching the POD type and geographic location of the PODs.

Additionally, translator module 204 may also fix imported data by removing unprintable strings and control characters and translating Universal Transverse Mercator (UTM) coordinates into latitude and longitude coordinates.

In one embodiment, water rights data may be translated by translator module 204 when a user initiates a search. In an alternative embodiment, data received by the water rights marketing system 101 may be translated before it is stored in data storage facility 210. Thus, the system's databases are not exact copies of the water rights agency databases 104, but instead are already in a format useable by the water rights marketing system 101 when a user search query is received. However, it should be appreciated that either arrangement may be used in the water rights marketing system 101. Maintaining the system's databases in the same format as the water rights agency databases 104, and thus translating the water rights data only when a user initiates a search query, makes updating the system databases from the water rights agency databases 104 easier and faster at the cost of slightly more processing time when a user performs a search. On the other hand, translating the data received prior to storing it in the system's databases makes updating the system's databases longer and more cumbersome, but decreases the processing time when a user performs a search. It should be understood that the water rights marketing system 101 may receive water rights data, hydrologic basins data, and property data from water rights agency databases 104, external data sources 108, and users 105A . . . 105N at any time, and at any scheduled interval. For example, the system 101 may update all databases once a week at a time when few users are likely to be using the system 101.

Comparative analysis module 207 is configured to use listings data in listings database 216 to determine an estimated market value for a water right in accordance with an automated comparative market analysis process and present the estimated market value for display by a user device 106A. Comparative analysis module 207 is also configured to normalize the market value of water rights for sale in a specified geographic region. Comparative analysis module 207 and the automated comparative market analysis process are described below in more detail.

User interface module 205 may be configured to provide one or more user interfaces configured to facilitate user interaction with system 101 and enable the user to run the processes described herein and implement the water rights marketing system and methods. For example, user interface module 205 may provide a user interface through which one or more functions, options, features, and/or tools may be provided to a user and through which user input may be received. The search module 203 may provide such interface. In certain embodiments, user interface module 205 may be configured to direct a user device 106A to display one or more web pages and/or any other content as may serve a particular implementation. In another embodiment, the user interface comprises a mobile application for use on a mobile handheld device such as a tablet or a smart phone. Indeed, the water rights marketing system may be configured to be accessed, run, and operated by a user on any type of handheld device.

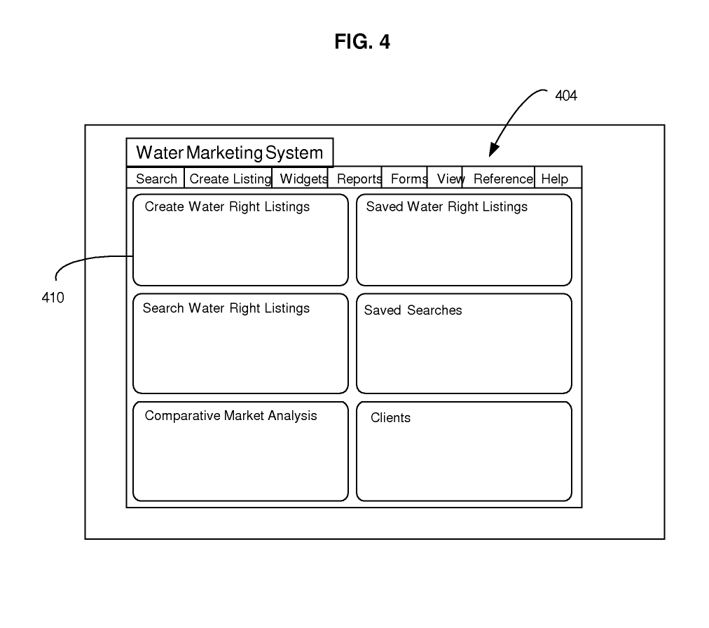

As shown in FIG. 4, listings module 206 and search module 203 may appear on a user interface 404 as customizable widgets 410, i.e., movable boxes or frames on the user interface 404. Indeed, many different features of the system 101 may be presented in the form of widgets. The user may customize the view of the user interface 404 when using the water rights marketing system 101 by configuring the arrangement of widgets on the user interface 404. Examples of widgets that may be presented on the user interface 404 include a create water right listing widget, a view water right listing widget, a search widget, a comparative market analysis widget, a clients list widget, a reports and forms widget, a saves searches widget, a favorites widget, and the like.

The water rights marketing system 101 may also be configured to detect changes to the water rights data in the data storage facility 210 by checking for changes in electronic or paper documents scanned and stored in the water rights agency database 104. Each such document is downloaded by the water rights marketing system 101 and hashed using any common low collision hashing algorithm to generate a fixed length string, such as a 64- or 128-character hash. The hash may be stored in the data storage facility, such as in water rights database 211, along with the time the document was downloaded and hashed. The next time the file is checked from the water rights agency database 104, a new hash is generated and compared with the stored hash. If the new hash is different the file has changed, in which case the water rights marketing system 101 saves the downloaded document in the appropriate database in data storage facility 210 and may provide a notification to an administrator or to a user via an alert on the website. All previous versions of the document can be stored over time to show a full history of changes. This can be done by storing every version of the document explicitly or by storing the incremental changes or any other algorithm known to those skilled in the art.

In some examples, one or more of the modules, data storage facility, and databases shown in FIG. 2 may be implemented at least in part as computing instructions (e.g., as one or more applications) residing within data storage facility 210 or other computer-readable medium and configured to direct processing module 202 to perform and/or direct one or more other components of water rights marketing system 101 to perform one or more of the processes and/or operations described herein. In certain embodiments, for example, search module 203 may be implemented, at least in part, as computing instructions residing within data storage facility 210 and configured to direct processing module 203 to perform one or more of the processes and/or functions described herein.

The components, modules, and databases of the water rights marketing system 101 are not limited to the singular or plural as used herein, it being understood that where the singular of a component is referenced, it could comprise multiple components, modules, or databases, and where multiple are referenced, there could be only one. Thus, reference to a database may include one or more databases, and reference to databases may comprise only one database or multiple databases.

The water rights marketing system 101 and associated components may be implemented in one or more subsystems. In one exemplary embodiment, the water rights marketing system 101 and its associated components are implemented by a state agency database system, and are only connected by internal networks. In this way, the state agency may provide water right alerts to users. It should further be appreciated that the system and methods described herein may operate directly from the databases external to the server, including the water rights agency database 104 and external data sources 108. In this way, the system does not have its own internal databases.

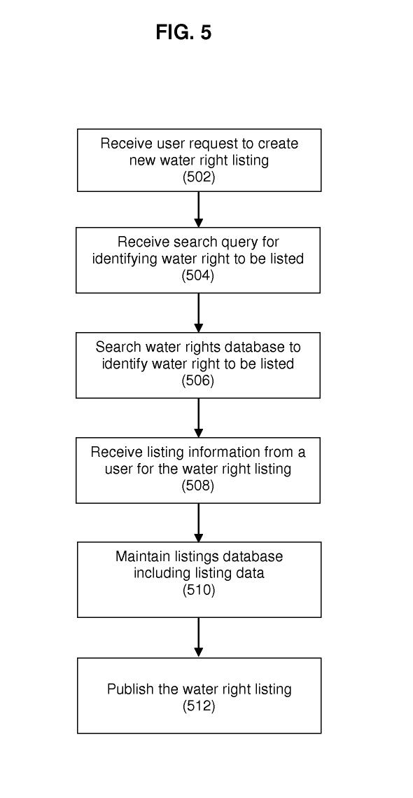

An exemplary method for creating a water right listing that implements functions of the water rights marketing system 101 described above is illustrated in FIG. 5. While FIG. 5 illustrates exemplary steps according to one embodiment, other embodiments may omit, add to, reorder, and/or modify any of the steps shown in FIG. 5. In certain examples, one or more of the steps of the method shown in FIG. 5 may be performed by a water rights marketing system such as water rights marketing system 101 described above.

Water rights marketing system 101 receives a user request to create a new water right listing (step 502). The request may specify information about the water right listing, such as but not limited to one or more author's names or user identifications, client name(s) (e.g., if the author is a listing agent for the seller client), a specification of the water type (e.g., a water right or a water share), and a name or descriptor for the water right listing. The user request may be initiated by the user selecting a selectable option accessible from a user interface to create a new water right. The selectable option may be provided in an options menu, a widget, or on a display of information associated with a water right.

Listings module 206 receives a search query for identifying a water right to be listed (step 504). The search query may be of any form or type as described herein. Listings module 206 then searches the water rights database 211 to identify the water right to be listed as the water right that satisfies the search query (step 506). If multiple water rights satisfy the search query, or where the matching water right includes multiple owners, the matching water rights and/or owners may be presented to the user for selection. Listings module 206 receives listing information provided by a user for the water right listing (step 508). Listing information may be provided by the user and received by the system 101 by any of the methods described herein. Water right marketing system maintains the listing data, including the data representative of the listing information inputted by the user and any water rights data associated with the water right, in listings database 216 (step 510). The water right listing may then be published for selective access by other users (step 512).

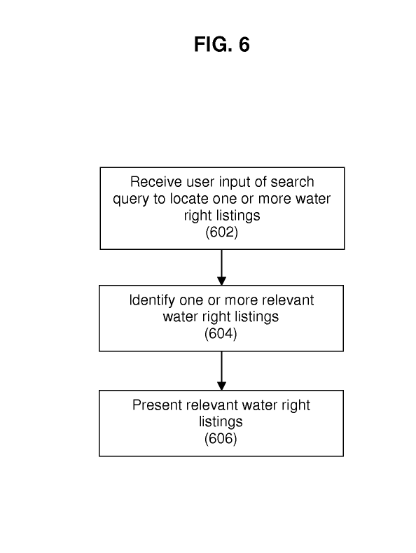

An exemplary method of searching published water rights listings that implements functions of the water rights marketing system 101 described above is illustrated in FIG. 6. While FIG. 6 illustrates exemplary steps according to one embodiment, other embodiments may omit, add to, reorder, and/or modify any of the steps shown in FIG. 6. In certain examples, one or more of the steps of the method shown in FIG. 6 may be performed by a water rights marketing system such as water rights marketing system 101 described above.

Water rights marketing system 101 may receive user input of a search query to locate one or more water right listings included in listings database 216 (step 602). The search query may be a water right listings data search or a geographic location search specifying criteria for identifying relevant water right listings. Based on the search query, the system searches listings database 216 and identifies the relevant water right listing(s) in listings database 216 (step 604), and presents the relevant water right listings to the user as the search results (step 606). Relevant water right listings are those that satisfy the user's search criteria, as described herein. The user may then view the details of the relevant water right listings.

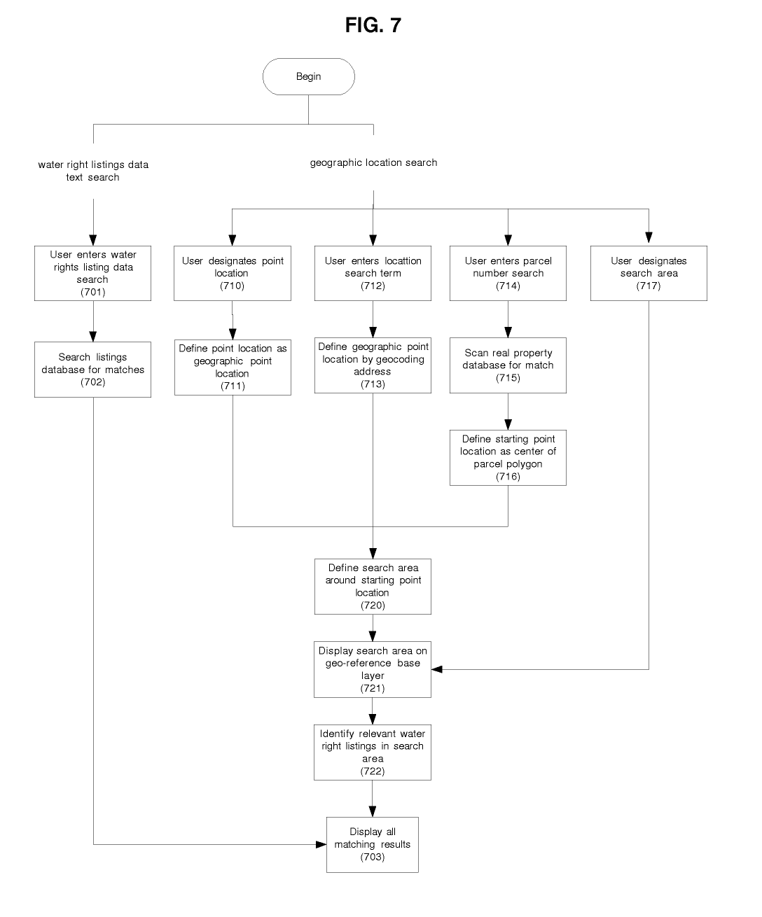

An exemplary embodiment of a flow chart of the water rights marketing method is illustrated in FIG. 7. FIG. 7 shows one embodiment of a process that implements functions of the water rights marketing system described above. While FIG. 7 illustrates exemplary steps according to one embodiment, other embodiments may omit, add to, reorder, and/or modify any of the steps shown in FIG. 7. In certain examples, one or more of the steps shown in FIG. 7 may be performed by a water rights marketing system such as the water rights marketing system 101 described above.

A search query may be received by search module 203 of the water rights marketing system 101 from a user in many different forms. In one form, a water right listings data search query may be performed by the user by defining search criteria on the user interface (step 701). The search criteria may include, or be configured to direct search module 203 to search, any type of listings data included in listings database 216, such as an asking price range, water right number, water right owner, quantity of water for sale, hydrologic basin where the water is for sale, approved natures of use of water, POD locations, water right listing reference number, water rights under nonuse, water rights having a specified status, and the like. It should be appreciated that the system may be configured to allow the user to search based on any of the listings data included in listings database 216. Search module 203 then scans listings database 216 to identify one or more water right listings having one or more listing data elements that match the search criteria (step 702).

In another form of search query, a geographic location search instead of, or in addition to, a water right listings data search may be performed by a user. For example, water right marketing system 101 may present a geo-reference base layer, such as a map or aerial photo, on a display associated with the user device. In one embodiment of a geographic location search, the user designates a geographic point location on the geo-reference base layer (step 710). This may be done by drag-and-drop, i.e. allowing the user to select a point location marker by clicking on the marker (with the use of a mouse or touch-pad or other user-controlled device) and dragging it onto the geo-reference base layer and dropping the marker at the desired location where the user wishes to query the system for water rights data, or it may be done by geo-locating via GPS, or other method known to those of skill in the art. Alternatively, the geographic point location may be designated by allowing the user to point a cursor or arrow or other similar marker controlled by the user at a location on the geo-reference base layer and then performing a user-controlled action to designate the geographic point location, such as clicking, double-clicking, using mind control, or right selecting and selecting an option from a pop-up menu. Regardless of the method followed, the system defines the geographic point location with the coordinate location of the geographic point location designated by the user (step 711).

In a further embodiment, the geographic search query may also be performed by searching for a physical location (a “location search”) based on a location identifier, such as by entering as the search criteria an address, a county, a zip code, and a public land survey area (such as a township and range, and optionally any sub-area such as a section, quarter-quarter section, and the like) (step 712).

In this embodiment, the system determines a geographic point location for the address or zip code by geocoding (step 713). Geocoding is the process of determining associated geographic point location coordinates from other information, such as street addresses or zip codes. Any type of geocoding system may be used, including those available through third parties.

In another embodiment, the geographic search query may be performed by performing a parcel search by the user entering a parcel number (step 714). The parcel number is of the type assigned or maintained by a state, county, or other government entity, such as a tax parcel number, for real property parcels. The system may scan the real property database 215 to locate a matching parcel (step 715). In one embodiment, a geographic starting point location is derived from the real property data by retrieving the polygon vector data defining the parcel's boundaries and determining the geometric center of the parcel polygon (step 716). Additionally or alternatively, the system may define a geographic starting point location from a parcel number search by scanning the real property database 215 to determine the physical address for the parcel number, and determining a geographic point location coordinate for the address as described above through the use of geocoding. In yet another embodiment, all or a part of the search area may be based on the parcel boundaries, which may be determined by real property data, such as any real property data obtained from external data sources 108.

Additionally or alternatively, the search module 203 may be configured to receive a user selection of a relevant jurisdiction, such as a state database, for the user's search query before entering any other search criteria. Receiving a user selection of the relevant jurisdiction allows the search module 203 to determine which databases will be searched for relevant water right listings to present in the search results.

Having identified a geographic point location by any of the above described methods, search module 203 defines a search area around the geographic starting point location (720). The search area generally comprises a set of vector data creating a polygon layer on the geo-reference layer. The search area may be any shape, including but not limited to a circle or polygon. In another embodiment, the search area is the hydrologic basin polygon in which the geographic point location is located, as defined by hydrologic basin data. The search area may also be any size. The system may have a default setting for the size of the search area, and may allow the user to adjust the default setting. The search area may be defined with the geographic point location anywhere within the search area, but preferably as the center of the search area. Search module 203 and/or user interface module 205 presents the search area on the geo-reference base layer on the user device (step 721). The user may refine and resize the search area at any time during the process as desired by the user, making the search area larger or smaller, or altering its shape and dimensions.

A geographic search area may be designated (step 717) by methods other than defining a geographic point location. For example, the search area may be defined by a user designating a hydrologic basin in the search query and search module 203 defining the search area as the hydrologic basin boundaries as specified by the hydrologic basins data included in hydrologic basins database 214. In this manner, a user may search all water right listings within a certain hydrologic basin. Additionally or alternatively, the user may define a search area as a polygon or rectangle drawn on the geo-reference base layer by the user, parcel boundaries for a parcel number entered by the user, a county, a zip code, and a public land survey area.

After the search area has been defined, the water rights marketing system 101 identifies relevant water right listings in the listings database 216 and transmits the search results to the user device for presentation to the user by the user device. To identify the relevant water right listings, the system performs a point-in-polygon test on some or all geo-referenced listing data, such as POD or POU, included in listings database 216 to determine if any listings data elements are located within the search area (step 722). The point-in-polygon test may comprise a ray casting method or angle addition. If a water right listing has a listing data element located within the search area, the listing data for that water right listing, and any other associated information, may be presented to the user as the search results (step 703). If a water right listing has no listing data element located within the search area, that water right listing is not a relevant water right listing and is not included in the search results.

The water right marketing system 101 may determine relevancy of water right listings based on the existence of only one listing data element being located within the search area. For example, a water right listing may have all but one POD located outside of the search area, but the location of one POD within the search area will result in the water right listing associated with that POD being defined as relevant. The criteria for determining relevancy may be adjusted or defined differently, whether by the system default settings or by the user based on user preferences. For example, a user may adjust the settings such that only those water right listings having all geo-referenced listing data elements within the search area are relevant. Or, in an alternative example, relevancy may be based only on heretofore or hereafter PODs.

In another embodiment, the system may receive a user designation of a hydrologic basin prior to defining the search area, in order to filter or narrow the listings data that search module 203 will scan to determine which water rights listings are relevant. Listing data for each water right listing are often tied in the system databases, directly or indirectly through correlation tables, to the hydrologic basin in which the water right's PODs are located. By determining in which hydrologic basin the search is to be performed, the system can eliminate significant amounts of listings data to be searched in determining the relevant water right listings. This can result in a significant decrease in processing time. The applicable hydrologic basin can be determined from the search query.

If the search query is based on a listings data search, and the search criteria includes a hydrologic basin number or identifier, the system searches only water right listings having listings data elements within the specified hydrologic basin. If the search query is a geographic search query, the geographic point location may be used to determine the default hydrologic basin for the search. This may be done by search module 203 performing a point-in-polygon test with the geographic point location coordinate compared against the water rights agency-defined polygons for hydrologic basins in the hydrologic basins database 214. Each water rights agency defines unique hydrologic basins with vector data in the form of polygons. The point location coordinate is compared against all hydrologic basin polygons until the relevant basin is identified from the system database. It is possible to convert bitmap images into vector-based files to begin the analysis should a water rights agency not provide vector data.

It should be appreciated that many other methods known to those of skill in the art, or in the spirit and scope of these teachings, may be used to determine the relevant hydrologic basin. However, it should be understood that determining the hydrologic basin is not required to implement the system. In an embodiment of the system and process, determining the relevant hydrologic basin is omitted.

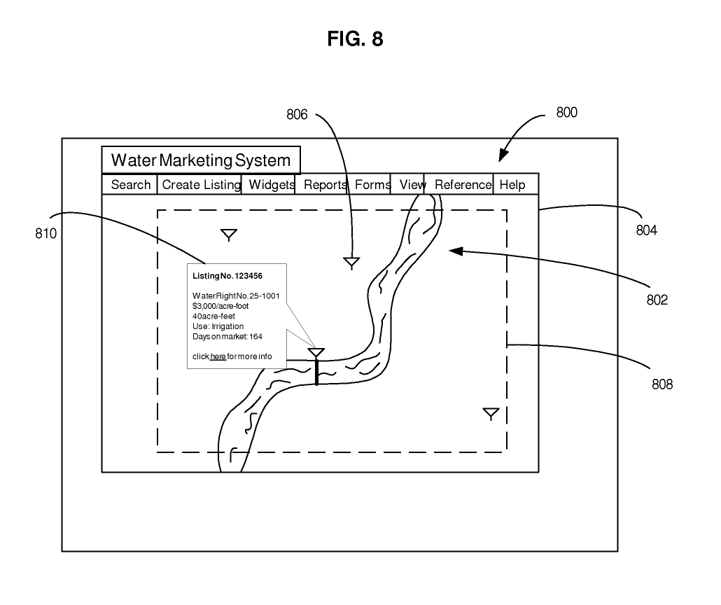

The search results may be presented in any format that displays the relevant water right listings. In one embodiment, as depicted in FIG. 8, the search results may comprise a user interface 800 including a search results layer 802 of geo-referenced listings data displayed on a geo-reference base layer 804. In this embodiment, the search results layer is vector data in the form of points, lines, and/or polygons representing the relevant geo-referenced listings data elements. The listing data elements represented in the geo-reference base layer output may include any geo-referenced listing data elements in the listings database 216, including but not limited to PODs, POUs, parcel boundaries, and the like, represented by a graphical object 806. In one embodiment, a POD that are located within the search area 808 are shown by a graphical object 806 on the map. The graphical object 806 may be determined and displayed according to any of the methods for displaying geo-referenced water rights data described in U.S. Non-Provisional patent application Ser. No. 13/772,996, filed on Feb. 21, 2013, which is incorporated herein by reference in its entirety. The graphical object 806 may be linked to the associated water rights listing, and as such may present any of the associated listing data or water rights listing information in a pop-up box 810 or the like when a user selects the graphical object 806, and/or may provide a link to view the water right listing information and listing data in another format, such as a results table as described below.

It should be understood that the geo-referenced display of listing data as described herein may also include different combinations and variations of the different embodiments and forms described herein, and that all such combinations and variations are within the scope of the implementation and operation of the water rights marketing system and method. In addition, the listings data represented in the search results on the geo-reference base layer is not limited to that data described herein, such as PODs, POD changes, POU changes, and exchange applications, such being merely exemplary, but may be any geo-referenced listings data.

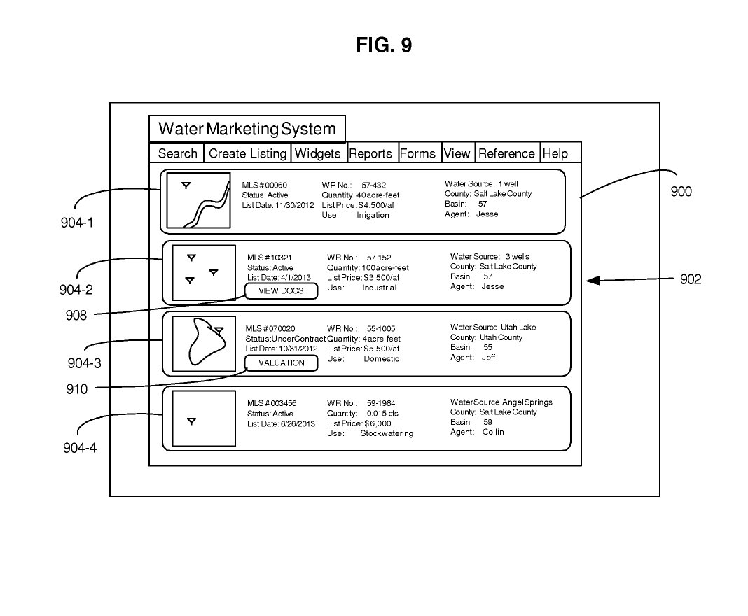

FIG. 9 shows another form of presenting the search results. In this embodiment, listings data and information associated with relevant water right listings may be presented in a non-geo-referenced format, such as a results table 902 included on user interface 900. In one embodiment, the search results may be displayed in the results table in a row and/or column format, with the listings data for each individual water right listing presented in a listing summary 904-1, 904-2, 904-3, and 904-4 in separate rows. The results table may also include separate columns, each column comprising any listing data available in the listings database 216, or derived therefrom, including, but not limited to, the water right number, owner name, asking price, quantity for sale, location, status, priority date, number of PODs (both heretofore and hereafter), POU, address, parcel number, nature of use, direction of a POD or POU change, and the like. The results table may also be configured to present additional listing information for a water right listing by a user selecting or mousing over a water right listing in the results table. The results table may also include for a water right listing 904-2 a selectable option 908 to access or view documents that have been uploaded and associated with the water right listing 904-2.

The results table may be customizable by a user according to user preferences. For example, the user may add and remove information items or columns displays in the results table, in order to select the desired listings data to be included in the results table for each water right listing. In another embodiment, the user may sort columns to list the water right listings in some type of sequential order. For example, the user may sort the table based on the asking price column, which would display the rows of water right listings in sequential order based on asking price. There are many ways in which a user can customize the results table, and it will be appreciated that all specific methods do not need to be mentioned here.

In another embodiment, the user may customize the search results, both in the results table and in the geo-reference search results, by applying filters to limit or narrow the water right listings deemed relevant. In this embodiment, the search results may include a set of selectable graphical objects representing one or more filters. For example, the search results may include filters based on any of the listing data. Selecting and applying filters will remove or hide water right listings that do not meet the filter criteria from the search results. However, water right listings data that do not meet the filter criteria are not deleted from the results table, but instead are simply “unselected,” indicating that the water right listings do not satisfy all filter criteria. In this way, the user may fully customize the water right listing search results to identify and pinpoint the water right listings that are most relevant and useful to the user.

The user may also customize the water right listings presented in the search results on the geo-reference base layer in two additional ways. In the first, as explained above, the user may click on a listings data graphical object to remove it or hide it from the geo-reference layer, which will also uncheck, unshade, highlight, or color it in the results table. In the second, the user may uncheck a water right listing in the results table, which will have the effect of removing or hiding the listings data graphical object from the geo-reference base layer.

The system may also be configured to allow the user to reconfigure the search criteria, including the geographic search area, as well as arrange and filter the search results at any time after search results have been presented to the user. In this way the user can customize and refine the search and search results as desired by the user to achieve the desired information relevant to the user's search.

For each search performed by a user, the system may also be configured to save the user's search in the system and user database 213, such as filters applied, the search area size and location, the display types, columns selected, water rights displayed or checked, to allow the user to retrieve the information or return to the same place during a later session.

The system may also be configured to deliver the search results from the user device 106A to other output devices, such as a printer or another user device. The system may also be configured to present search results in a different format, such as PDF, spreadsheet, HTML, and the like. In one embodiment, the user may print the search results. In another embodiment, the user may send the search results to another user by way of a messaging service, such as not but not limited to email, text messaging, SMS, MMS, fax, and the like.

The system may also be configured to generate reports as desired by a user. For example, a water activity report could show an active water right listing and any other past water right listing for that same water right throughout its history. Other reports may include, as desired by the user, comparative pricing reports, market reports, absorption reports, sales per month, market summaries, and the like. In another embodiment, the system may be configured to generate forms for the user to fill out, such as listing agreement forms, water right purchase agreements, and the like. Form generation can be completed from a form archives and may be pre-populated with listings data for a selected water right listing.

Through the listings database 216, which may include listings data representative of transactions and sales prices, the water rights marketing system 101 becomes a repository of water rights valuations that can be used in a comparative market analysis to aid in the valuation of other water rights. The water rights marketing system 101 provides various tools to aid in the comparative market analysis.

The water rights marketing system 101 is a valuable tool for performing a comparative market analysis. In one embodiment, a user may utilize various water rights listings in the listings database 216 to make a subjective conclusion as to the value of a water right. The water rights marketing system 101 allows a user to search and select which water right listings to include as comparables in the analysis. For example, a user may use search module 203 to search the listings database 216 for water rights listings having listings data elements located within a certain geographic region, or may search for water rights listings associated with water rights of a particular use type and/or quantity. Searching for water right listings to be used as comparables may be performed according to any method as described herein for searching for relevant water right listings.

Using the valuations provided for each of the water right listings included in the search results, such as asking price or sale price, the user may make a subjective determination about the value of a water right. The water rights marketing system 101 may also aid in performing calculations, such as calculating the average price per unit (acre-foot or cfs) of the selected water right listings data.

The water rights marketing system 101 can also aid the user in finding the most relevant water right listings to include as comparables in the analysis. For example, the water rights marketing system 101 may rank, based on user selections and/or user preferences, the relevance of water right listings for use in the analysis based on date of the transaction, similarity of the water rights data (e.g., quantity or use type), and proximity in location to the water right to be valued. The water rights marketing system 101 can automatically return a list of the relevant water rights, and then allow the user to filter through those based on the user's preferences or expertise.

An advantage with water rights marketing system 101 is that it maintains a listings database 216 data that can be quickly searched by any number of criteria and viewed by a user, thus providing a quick and powerful way for a user to quickly identify and consolidate all relevant transactions with a wealth of information readily available for viewing. Currently no such system is known to exist.

The water rights marketing system 101 may also determine a market value for a water right in accordance with an automated comparative market analysis process. In this embodiment, comparative analysis module 207 may use listing data to determine an estimated market value for a given water right (or a hypothetical water right), and may also be used to normalize the value of all water rights for sale in a geographic region. This process provides an objective valuation based on data maintained by water rights marketing system 101. Currently, determining an objective, normalized value of water rights is not possible. For example, determining a market value of buildings and structures on land is based on comparing tangible features of the structures, such as the number of kitchens and baths, square footage, bedrooms, and lot size. In the water rights context, however, the problem with valuing water rights is that the features of water rights are less tangible and more abstract. Thus, there has been no baseline market for developing comparables and make comparing apples-to-apples and oranges-to-oranges comparisons.

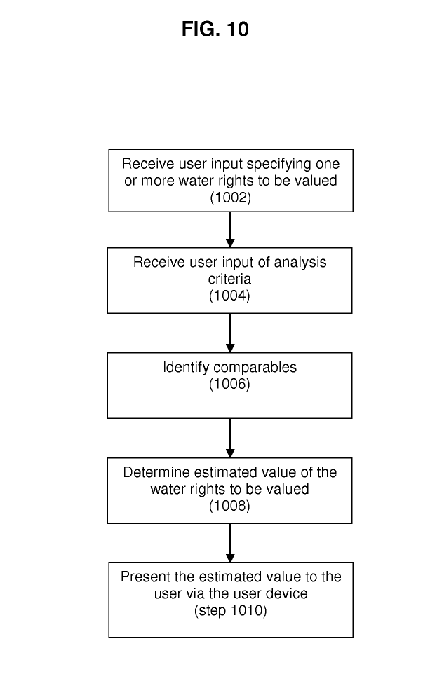

An exemplary automated water right valuation process is illustrated in FIG. 10. While FIG. 10 illustrates exemplary steps according to one embodiment, other embodiments may omit, add to, reorder, and/or modify any of the steps shown in FIG. 10. In certain examples, one or more of the steps of the method shown in FIG. 10 may be performed by a water rights marketing system such as water rights marketing system 101 described above.

Comparative analysis module 207 and/or search module 203 receives, from a user device, user input specifying one or more water rights to be valued (step 1002). In one embodiment, the one or more water rights to be valued may be included in water rights database 211. The user input may include a search query to identify the one or more water rights to be valued. For example, the user input may comprise a textual search based on any water rights data, such as a water right number, owner name, water source, or the like. Comparative analysis module 207 and/or search module 203 may search water rights database 211 to identify one or more water rights having water rights data elements that match the search query. If multiple water rights match the search query, the user may be prompted to select one or more of the water rights included in the search results to be valued. Additionally or alternatively, the user input may include a geographic search to identify one or more water rights to be valued. The search to identify one or more water rights to be valued may be performed by any of the search methods described in U.S. Non-Provisional patent application Ser. No. 13/772,996, filed on Feb. 21, 2013, and U.S. Non-Provisional patent application Ser. No. 13/923,686, filed on Jun. 21, 2013, which are incorporated herein by reference in their entireties.

In another embodiment, a water right to be valued may be a hypothetical water right, and the user input may include hypothetical water right data values (e.g. quantity, use type, location or hydrologic basin, etc.) entered by the user.

Comparative analysis module 207 may also receive user input representative of analysis criteria for the selected water right (step 1004). Analysis criteria may include any designation of a portion of a water right to be valued. For example, analysis criteria may include the quantity of water to be sold under the selected water right, if it is less than the full amount approved for use by the water rights agency for the selected water right. In another example, if the water right has multiple approved natures of use, analysis criteria may include a designation of a subset of the approved natures of use.

Comparative analysis module 207 identifies comparable water right listings (“comparables”) to be used in the analysis (step 1006). In one embodiment, comparables may be automatically identified and selected from water rights listings included in listings database 216 in accordance with a comparables heuristic stored in data storage facility 210. The comparables heuristic may be based on factors such as geographic proximity of water rights associated with water rights listings to the water right to be valued, temporal proximity of transactions associated with water right listings to the date of the analysis of the water right being valued, the quantity of water associated with the water rights listings, a status of the water rights listings, the hydrologic basin of the water right to be valued, a statistical margin of error, and the like. For example, the system may automatically exclude certain water right listings that fall outside a determined range of statistical margin of error. In one embodiment, the comparables heuristic may be defined, managed, and/or modified by a user.

Additionally or alternatively, the comparables may be selected by a user from a set of water right listings presented to the user by comparative analysis module 207 and/or search module 203. The set of water right listings presented to the user may be identified by any method as may suit a particular implementation. In one embodiment, the set of water right listings is identified and presented to the user in accordance with the search methods described above.

Comparative analysis module 207 then determines an estimated value of the selected or hypothetical water right based on the comparables and any analysis criteria (step 1008) and presents the estimated value to the user via the user device (step 1010). The estimated value of a water right is determined through statistical regression analysis. Comparative analysis module 207 can use any regression analysis algorithm. More preferably, the algorithm used by comparative analysis module 207 to determine the value may be any algorithm in the family of parametric regression analysis. In one embodiment, the water rights marketing system 101 determines the value of water rights using the least squares regression analysis. This method is particularly useful where the relationship between quantity of water and its value is substantially linear. In this algorithm, comparative analysis module 207 solves the following equation for X:

A·X=B (1)

where A is the M×N matrix of the quantity of water included in each comparable for all categories of water use;

B is the 1×N matrix of the total valuation for each comparable, i.e. sales price or list price for each comparable;

X is the value of water per unit (e.g. $ per acre-foot, cubic foot per second, etc.) for each use type in the market defined by the comparables;

M is the number of categories of approved types of water use designated by the water rights agency (e.g. irrigation, domestic, industrial, municipal, etc.); and

N is the number of comparables used in the analysis, which can be selected by a user operating the system, or which can be generated automatically by the system.

Comparative analysis module 207 solves equation (1) for X by computing a vector X that minimizes the Euclidean 2-norm∥B−A·X∥̂2. The equation may be under-, well-, or over-determined (i.e., the number of linearly independent rows of a matrix can be less than, equal to, or greater than its number of linearly independent columns). If A is square and of full rank, then X (but for round-off error) is the “exact” solution of the equation. Comparative analysis module 207 computes a vector X that minimizes the Euclidian 2-norm because the matrix may not be full and because the comparables data may not be perfect matches for the subject water right to be valued.

In another embodiment, M is the number of categories of approved types of use for which the comparables have values other than zero. For example, if there are no stockwatering and no municipal water rights in the comparables, then the algorithm would not include columns for those use types. The vector X will give the valuation for water rights based on use type per unit of quantity.

A seller could choose to list his water rights for sale at the price determined by the system, or perhaps the seller may wish to use that price as a base price and then adjust it accordingly for purposes of negotiation. When the seller's water rights sell, the sales data will then be added to the listings database 216, and that sale will then be available to be used as a comparable for other water rights to be sold. The benefit of this method and algorithm is that it utilizes a quantity of market data stored in the water rights marketing system 101 and finds a more advanced market value for the different types of water being evaluated. In this way, water rights marketing system 101 begins to normalize water rights valuations as increasing numbers of comparables (i.e. market data) are added to the water rights marketing system 101. This, in turn, allows people in the market to place more confidence in water rights valuations done by the water rights marketing system 101.

A few hypothetical examples of how this method works are presented herein. These examples are only for illustration purposes, and are not intended to be limiting in any way. In each example, the system uses the least squares regression analysis to solve for X as described above to determine a value per acre-foot for each of the types of water use the seller is selling.

### Example 1

The water rights marketing system 101 identifies five listings for comparison, based on a search for relevant comparables. In this example, all comparables have the same use type. The values of these water rights reflect a value per acre-foot of about $10,000. The matrices A, B, and X are as follows:

1A: Quantity Sold (ac-ft/yr)

| | | Stock- | Do- | | | |
|---|---|---|---|---|---|---|
| | Irrigation | watering | mestic | Municipal | Power | Other |
| Comp. 1 | 100 | 0 | 0 | 0 | 0 | 0 |
| Comp. 2 | 10 | 0 | 0 | 0 | 0 | 0 |
| Comp. 3 | 5 | 0 | 0 | 0 | 0 | 0 |
| Comp. 4 | 10 | 0 | 0 | 0 | 0 | 0 |
| Comp. 5 | 1 | 0 | 0 | 0 | 0 | 0 |

1B: Price

| | Price |
|---|---|
| Comp. 1 | $1,015,480 |
| Comp. 2 | $98,954 |
| Comp. 3 | $56,123 |
| Comp. 4 | $109,000 |
| Comp. 5 | $9,817 |

1X: Value per acre-foot for each use type

| | | Stock- | Do- | | | |
|---|---|---|---|---|---|---|
| | Irrigation | watering | mestic | Municipal | Power | Other |
| Value | $10,162.13 | 0 | 0 | 0 | 0 | 0 |

Thus, based on these five comparable transactions the water rights marketing system 101 determines that each acre-foot has a value of $10,162.13.

### Example 2

The second example shows the effect of one bad comparable on the analysis. Again, this example assumes only one use type for all comparables. Here, all water rights have a value of about $10,000 per acre-foot, except for comparable 2, whose value is increased by a factor of 10.

2A: Quantity Sold (ac-ft/yr)

| | | Stock- | Do- | | | |
|---|---|---|---|---|---|---|
| | Irrigation | watering | mestic | Municipal | Power | Other |
| Comp. 1 | 100 | 0 | 0 | 0 | 0 | 0 |
| Comp. 2 | 10 | 0 | 0 | 0 | 0 | 0 |
| Comp. 3 | 5 | 0 | 0 | 0 | 0 | 0 |
| Comp. 4 | 10 | 0 | 0 | 0 | 0 | 0 |
| Comp. 5 | 1 | 0 | 0 | 0 | 0 | 0 |

2B: Price

| | Price |
|---|---|
| Comp. 1 | $1,015,480 |
| Comp. 2 | $989,540 |
| Comp. 3 | $56,123 |
| Comp. 4 | $109,000 |
| Comp. 5 | $9,817 |

2X: Value per acre-foot for each use type

| | | Stock- | Do- | | | |
|---|---|---|---|---|---|---|
| | Irrigation | watering | mestic | Municipal | Power | Other |
| Value | $11,033.04 | 0 | 0 | 0 | 0 | 0 |

Thus, even with the significantly different value for Comparable 2 in this example, the water rights marketing system 101 determines that the value of the water rights is $11,033.04. This is a much better estimate of actual market value than a simple average calculation, which in this example would yield $17,301 per acre foot.

### Example 3

A third example utilizes two water use types: irrigation and stockwatering.

3A: Quantity Sold (ac-ft/yr)

| | | Stock- | Do- | | | |
|---|---|---|---|---|---|---|
| | Irrigation | watering | mestic | Municipal | Power | Other |
| Comp. 1 | 100 | 4 | 0 | 0 | 0 | 0 |
| Comp. 2 | 40 | 0.9 | 0 | 0 | 0 | 0 |
| Comp. 3 | 100 | 18 | 0 | 0 | 0 | 0 |

3B: Price

| | Price |
|---|---|
| Comp. 1 | $500,000 |
| Comp. 2 | $163,600 |
| Comp. 3 | $650,000 |

3X: Value per acre-foot for each use type

| | | Stock- | Do- | | | |
|---|---|---|---|---|---|---|
| | Irrigation | watering | mestic | Municipal | Power | Other |
| Value | $4,429.24 | $11,570.84 | 0 | 0 | 0 | 0 |

To check these calculated values against the original purchase price, the price of the three comparables would be as follows:

3B′: Price based on Calculated Value

| | Price | Difference |
|---|---|---|
| Comp. 1 | $489,207.47 | 2.16% |
| Comp. 2 | $187,583.40 | 14.66% |
| Comp. 3 | $651,199.17 | 0.18% |

Thus, it can be seen that comparable 2 for some reason may not be a good comparable. It may be that it is located in a different geographic region where values are different, or other factors may affect the value. The water rights marketing system 101 allows the user to select which comparables to include in the comparative market analysis.

It should be appreciated that the comparables need not to be water right listings, but simply may be water rights and water rights data having valuation data. Thus, a listings database is not required to implement the comparative analysis process, but merely any database including valuation data for water rights. However, it should be recognized that using the listings database 216 and water right listings, as described herein, in the automated comparative analysis process provides a quick and efficient means for gathering accurate valuation data while correlating listing data to water rights data, real property data, and geographic regions.

The water right marketing system 101 may also provide a method for determining an estimated market value of a water right based on the depletion limit of water rights. In this method, comparative analysis module 207 also accounts for depletion by considering the depletion factor from the quantity of water for all use types and normalizing the value of water based on depletion.

The depletion factor simply represents a percentage of the quantity of water that is lost (e.g. consumed) to the natural hydrologic system for a given water right. For example, studies indicate that approximately 50% of the water applied to irrigate alfalfa in Utah is consumed by the plants, while the remaining 50% infiltrates into the ground and returns to the natural hydrologic environment. However, the actual depletion factor often varies from location to location, depending on local climate, topography, and ground conditions. In addition, the depletion factor varies depending on use type. In some circumstances, water rights agencies adopt or specify the depletion factors for water rights, and in other circumstances research studies and publications provide depletion factors or formulas to calculate a depletion factor. For example, the Utah Division of Water Rights adopts the consumptive use data set forth in Consumptive Use of Irrigated Crops in Utah, Final Report, by Robert W. Hill (1998), to determine depletion factors for irrigation. In other cases, the depletion factors are based on weather station data.

In one exemplary embodiment, the water rights marketing system 101 may utilize weather station data, both archived and live, to determine depletion factors. Weather station data can be obtained from external data sources 108 and included in data storage facility 210 of water rights marketing system 101. Often this information is obtained from the water rights agency database 104. For jurisdictions not yet running a real time weather station data option, water rights marketing system 101 may incorporate consumptive use data from whatever published report(s) or data that the jurisdiction is using, as in Utah.

To account for depletion factors, comparative analysis module 207 creates a new matrix A′ for the quantity of water approved to be depleted under each comparable, based on each use type. This could be done by multiplying A by a similarly-sized depletion matrix D containing the depletion factor for each use type. The depletion data for A′ could be obtained from the data storage facility 210, such as the listings database 216, which may contain specific information about depletion for each water right listing. Accordingly, equation (1) as set forth above becomes equation (2) below:

A′·A=B (2)

where A′=A×D; and

D is the M×N matrix of the depletion factor for each use type for each comparable.

In another embodiment, available for use in a subjective comparative analysis, comparative analysis module 207 may determine a single price per unit ($/acre-foot) for all use types for a single water right or transaction. This can be done by determining the depletion amount for each use type (quantity approved multiplied by depletion factor), and then dividing the total price by the sum of those amounts. A price per unit for many different water rights or transactions can be obtained, and then those results can be averaged or used to determine a value of a water right. The following example is instructive of this method:

### Example 4

A seller desires to know the value of a water right, which has 100 acre-feet approved for irrigation, 5 acre-feet for stockwatering, and 1 acre-foot for domestic use. There are two comparables, and their adjusted quantities based on depletion are as follows:

4A: Comparable #1

| | Irrigation | Stockwatering | Domestic | Total |
|---|---|---|---|---|
| Quantity | 100 | 0 | 0 | 100 |
| Depletion | 65% | 100% | 20% | |
| Factor | | | | |
| Adjusted | 65 | 0 | 0 | 65 |
| Quantity | | | | |

| | |
|---|---|
| Sales Price | $500,000 |
| Unit Price - pre-depletion ($/ac-ft) | $5,000 |
| Unit Price - depletion basis ($/ac-ft) | $7,692 |

4A: Comparable #2

| | Irrigation | Stockwatering | Domestic | Total |
|---|---|---|---|---|
| Quantity | 40 | 10 | 2 | 52 |
| Depletion | 65% | 100% | 20% | |
| Factor | | | | |
| Adjusted | 26 | 10 | 0.4 | 36.4 |
| Quantity | | | | |

| | |
|---|---|
| Sales Price | $286,000 |
| Unit Price - pre-depletion ($/ac-ft) | $5,500 |
| Unit Price - depletion basis ($/ac-ft) | $7,857 |

Taking the average of the unit prices on the depletion basis at $7,775 per acre-foot, the value of the seller's water right can be determined as follows:

4B: Value of Water Right

| | Irrigation | Stockwatering | Domestic | Total |
|---|---|---|---|---|
| Quantity | 100 | 5 | 1 | 106 |
| Depletion | 65% | 100% | 20% | |
| Factor | | | | |
| Adjusted | 65 | 5 | 0.2 | 70.2 |
| Quantity | | | | |

| | |
|---|---|
| Unit Price - depletion basis ($/ac-ft) | $7,775 |
| Total Value | $545,805 |

Alternatively, the seller could use the unit price—depletion basis values as a guide to subjectively determine a value of the water right.

It should be understood that any of the above methods for valuing water rights can be used alone or in combination with each other in order to provide a robust and accurate estimation of market value for water rights.

In one embodiment, comparative analysis module 207 performs the valuation analysis to determine the value of a given water right. Comparative analysis module 207 may present a graphical user interface on a user device as a separate and unique widget on the user interface. Additionally or alternatively, comparative analysis module 207 may present a graphical user interface configured to allow a user to perform the valuation analysis as part of a user interface presented by water right listings module 206. For example, when a user is creating a new water right listing, a user interface for creating the listing may include a user selectable option to perform a water right valuation analysis. In another embodiment, as depicted in FIG. 9, when a user is viewing a water right listing after performing a water right listings search, as described above, the water right listing may include a user-selectable option 910 to perform a market valuation analysis for the water right listing, or it may automatically present the estimated valuation determined as described herein.

The subjective comparative market analysis provides the user with robust search options and provides a side-by-side comparison of key valuation parameters allowing the user to add or remove various water right listings or make individual price adjustments to any individual parameter to best match the attributes of the water right being valued to obtain the most accurate valuation in the eyes of the user. For reference in the subjective comparative market analysis, the automated value for each water right may be shown where available as well as the depletion values for each use type, ensuring an apples to apples comparison. Because depletion is a key valuation attribute and is unique to water, and is accounted for by comparative analysis module 207, the water rights marketing system 101 is unique and provides a more accurate and robust valuation of water rights.

Additionally, comparative analysis module 207 can weight or adjust the comparables based on user selections of relevance or user adjustments. For example, a user can adjust a comparable based on subjective information known to the user, such as whether a lower valuation is the result of other factors not evident in the water rights listing. In addition, water rights agency policies that affect water rights can be used to weight the comparables valuations or the final comparative market analysis. For example, a policy restricting changing a POD of a water right in certain directions or areas could be represented by a policy factor of less than 1.0. The value of the policy factor could be estimated by the user, or it could be determined by the system as additional water right listings data are added to the system.

In another embodiment, the system can be designed to track the value and/or asking price of water rights. When a water right listing is published with a water right at a certain value, or when the comparative analysis module 207 determines that the value of water rights has reached a certain price point, an alert or notification can be sent to a user who has requested such. For example, if a user wants to purchase water rights in hydrologic basin 15, the system would track to determine when a water right listing arrives with an asking price at or below a price determined by the user. The user could also determine when the actual sales prices determine that the market value of water rights is at or below the user's determined price, even if no listings are showing water rights at or below that price. The same could be done for a potential seller, who would only want to sell when the value of water exceeds a certain price.

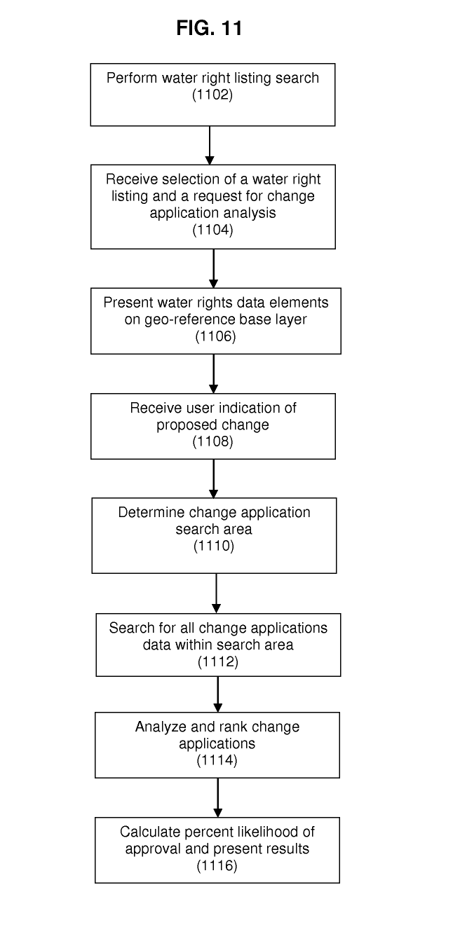

In a further embodiment, the water rights marketing system 101 may utilize and incorporate any of the features described in U.S. Non-Provisional patent application Ser. No. 13/772,996, filed on Feb. 21, 2013, and U.S. Non-Provisional patent application Ser. No. 13/923,686, filed on Jun. 21, 2013, which are incorporated herein by reference in their entireties. For example, as shown in FIG. 11, the system may be configured to determine the probability that a specified water right change application for a water right associated with a selected water right listing will be approved. While FIG. 11 illustrates exemplary steps according to one embodiment, other embodiments may omit, add to, reorder, and/or modify any of the steps shown in FIG. 11. In certain examples, one or more of the steps of the method shown in FIG. 11 may be performed by a water rights marketing system such as water rights marketing system 101 described above.

The user may perform a water right listing search by any of the methods described herein (step 1102), select a water right listing from the search results and initiate a request for a change application analysis on the water right associated with the water right listing (step 1104). The water rights marketing system 101 displays to the user a geo-reference base layer including one or more graphical elements representing the heretofore water rights data elements, such as PODs or POUs (step 1106). The user may then select the graphical object(s) representing the heretofore point(s) to be moved, and then indicates the hereafter point(s) on the geo-reference base layer (step 1108). The water rights marketing system 101 determines a search area (step 1110), either automatically based on the water rights data and/or the hereafter point(s), and runs a search of water rights database 211 identifying all water right changes within in the search area (step 1112). The system 101 analyzes water right data for each water right change and groups those water right changes that are most similar to the user's proposed change, and ranks them, such as by age, starting with the most current (step 1114). A percent likelihood of approval of the desired change application is calculated based on a change application heuristic, and the list of the water right changes and the percent likelihood of approval of the desired change application are presented to the use (step 1116).

As described above, the water rights marketing system 101, methods, and products described herein may also be utilized for water shares, in like manner as they are utilized for water rights. For example, the comparative market analysis would be based on volume of water allowed per share for a specific water company and other nearby companies, and then average out share prices between companies for same quantities. The system may be configured to plot the areas based on place of use for each water company.

In another aspect of the invention, the water rights marketing system 101 is configured to allow interested buyers to post requests for water rights. Other users on the system, particularly sellers, can then respond to those requests. In another aspect, the system allows buyers looking for large quantities of water to request proposals for sales of water. Often, a buyer such as a municipality or large industrial process, cannot find all of the water it needs from one or a few sellers, but instead must piece together and purchase many different small quantities of water. The water rights marketing system 101 can streamline that process by allowing the buyer to specify the water it needs to buy, and then scanning the listings database 216 and presenting the buyer with a comprehensive list of all water rights listings that satisfy the buyer's needs. In this way, a buyer can identify, in a matter of a few minutes, a large quantity of water to purchase. This aspect integrates “request for proposal” (RFP) management tools to assist jurisdictions or large single purchasers to obtain group proposals or automatically aggregate many smaller individual offers into one solution for consideration. The water rights marketing system 101 can automatically determine the use type changes and ultimately the quantity of water being offered automatically while screening out ineligible rights.

The water rights marketing system, methods, and products described herein provide a unique and powerful tool for marketing, selling, and valuing water rights that otherwise is not available with prior art systems. In addition, the water rights marketing system provides a tool for marketing, selling, and valuing water rights based on information from a water rights agency, as well as from private parties. It provides a single location for buyers and sellers to come together. Doing this creates a more stable pricing market and more accurate method for valuing water rights. Even more, it creates a database of water rights sales information never before available. With this data, more accurate valuations of water rights can be accomplished, creating more uniformity in water rights pricing and valuations, and allowing water rights to be better utilized in commercial markets.

What is claimed is:

1. A method comprising:
maintaining, by a water rights marketing system, a listings database comprising listings data representative of a plurality of water right listings;
receiving, by the water rights marketing system from a user device, data representative of a search query for identifying one or more relevant water right listings included in the plurality of water right listings, the search query including one or more search criteria defined by a user of the user device;
identifying, by the water rights marketing system in response to the receiving of the search query, the one or more relevant water right listings, the one or more relevant water right listings each having one or more listings data elements that satisfy the one or more search criteria; and
presenting, by the water rights marketing system, the one or more relevant water right listings for display by the user device,
wherein the listings data for at least one of the plurality of water right listings includes
water rights data received from a water rights agency database and associated with the at least one of the plurality of water right listings, and
data representative of listing information provided by the user or another user.

2. The method of claim 1, further comprising:
providing, by the water rights marketing system via a user interface on the user device, one or more filters for selective application by the user for defining the one or more search criteria, the one or more filters corresponding to listings data, and
receiving, by the water rights marketing system from the user device, a selective application by the user of at least one of the one or more filters.

3. The method of claim 1, wherein the one or more search criteria are based on at least one of a quantity of water, an approved nature of use of water, a hydrologic basin identifier, a county, a water source, a type of water right, and a type of point of diversion.

4. The method of claim 1, wherein the one or more search criteria include a geographic search area.

5. The method of claim 4, wherein the geographic search area comprises a polygon defined by a user on a geo-reference base layer, a hydrologic basin, a county, a public land survey area, or a real property parcel.

6. The method of claim 4, further comprising:
defining the geographic search area by
receiving, by the water rights marketing system from the user device, user input of at least one of an address, a parcel number, a tax identification number, a water right reference number, and a user placement of a graphical object on a geo-reference base layer;
determining, by the water rights marketing system, a geographic point location based on the user input; and
defining, by the water rights marketing system, the geographic search area based on the geographic point location.

7. The method of claim 4, wherein the identifying the one or more relevant water right listings included in the plurality of water right listings comprises:
searching, by the water rights marketing system, the listings database to identify the one or more relevant water right listings as having at least one geo-referenced listings data element located within the geographic search area.

8. The method of claim 7, wherein the at least one geo-referenced listings data element is a point of diversion or a place of use.

9. The method of claim 1, wherein the presenting comprises:
displaying, by the water rights marketing system, a geo-reference base layer and one or more graphical elements representing one or more geo-referenced listings data elements of the one or more relevant water rights on the geo-reference base layer.

10. The method of claim 9, wherein the geo-reference base layer comprises a map, a satellite image, or an aerial image.

11. The method of claim 1, wherein the presenting comprises:
displaying, by the water rights marketing system, a results table including a listing summary for each of the one or more relevant water right listings,
wherein each listing summary includes at least a portion of the listings data associated with each of the one or more relevant water right listings.

12. The method of claim 11, further comprising:
providing, by the water rights marketing system, one or more selectable options for accessing additional information associated with the one or more relevant water right listings.

13. The method of claim 1, further comprising:
receiving, by the water rights marketing system, the water rights data associated with the at least one of the plurality of water rights from the water rights agency database; and
maintaining, by the water rights marketing system, a water rights database comprising the water rights data.

14. The method of claim 1, embodied as computer-executable instructions on at least one non-transitory computer-readable medium.

15. A method comprising:
receiving, by a water rights marketing system from a user device, listing information provided by a user of the user device to create a water right listing associated with a water right;
maintaining, by the water rights marketing system, a listings database including listing data associated with the water right listing; and
publishing, by the water rights marketing system, the water right listing,
wherein the listing data comprises data representative of the listing information provided by the user and water right data associated with the water right and received from a water rights agency database.

16. The method of claim 15, further comprising:
receiving, by the water rights marketing system from the water rights agency database, water rights data representative of a plurality of water rights; and
maintaining, by the water rights marketing system, a water rights database comprising the water rights data, including the water right data associated with the water right.

17. The method of claim 16, further comprising:
receiving, by the water rights marketing system from the user device, a search query for identifying the water right included in the plurality of water rights; and
searching, by the water rights marketing system, the water rights database to identify the water right.

18. The method of claim 15, further comprising:
receiving, from the user device, a user request to create the water right listing.

19. The method of claim 18, further comprising:
providing, by the water rights marketing system in response to the receiving of the user request, a graphical user interface for display by the user device and configured to facilitate input of the listing information from the user of the user device.

20. The method of claim 19, wherein:
the graphical user interface includes one or more fields for inputting the listing information; and
at least one of the one or more fields is pre-populated with corresponding water right data received from the water rights database.

21. The method of claim 15, wherein the listing information includes one or more documents uploaded by a user.

22. The method of claim 15, wherein the listing information includes transaction information associated with a sale of the water right.

23. The method of claim 15, further comprising:
receiving, by the water rights marketing system, one or more user preferences specifying access rights for a portion of the water rights information included in the water right listing.

24. A method comprising:
maintaining, by a water rights marketing system, one or more water rights databases comprising water rights data corresponding to a plurality of water rights, the water rights data including water right valuation data;
receiving, by a water rights marketing system, user input specifying a water right to be valued;
identifying, by the water rights marketing system, comparable water rights data included in the one or more water rights databases; and
determining, by the water rights marketing system, an estimated value of the water right based on the valuation data included in the comparable water rights data.

25. The method of claim 24, further comprising:
searching, by the water rights marketing system in response to the receiving the user input specifying the water right to be valued, the one or more water rights databases to identify the water right to be valued,
wherein the determining of the estimated value of the water right is further based on water rights data included in the one or more water rights databases corresponding to the water right.

26. The method of claim 24, wherein the identifying the comparable water rights data is performed in accordance with a comparables heuristic.

27. The method of claim 24, wherein:
the one or more water rights databases include a listings database including listings data representing a plurality of water right listings, and
the water right valuation data is included in the listings data in the listings database.

28. The method of claim 27, wherein the identifying the comparable water rights data comprises:
presenting, by the water rights marketing system, a set of water right listings included in the plurality of water right listings for selection by the user;
receiving, by the water rights marketing system, a user selection of one or more of the water right listings included in the set of water right listings; and
identifying, by the water rights marketing system, the listings data associated with the selected one or more of the water right listings included in the set of water right listings as the comparable water rights data.

29. The method of claim 24, wherein the determining the estimated value is performed in accordance with a statistical regression analysis.

30. The method of claim 24, wherein the determining the estimated value is further based on a depletion factor.

31. The method of claim 30, wherein the depletion factor is included in the comparable water rights data or determined based on the comparable water rights data.

32. A water rights marketing system comprising:
a water rights database comprising water rights data representative of one or more water rights;
a listings module configured to facilitate generation of one or more water right listings associated with the one or more water rights;
a listings database including listing data representative of the one or more water right listings;
a search module configured to receive a search query from a user device and search the listings database to identify one or more relevant water right listings included in the one or more water right listings; and
a display module configured to display at least a portion of the one or more relevant water right listings,
wherein the listing data associated with the water right listing included in the one or more water right listings includes
water rights data corresponding to the one or more water rights associated with the one or more water rights listings, and
data representative of listing information provided by a user of the user device.
